(19) United States
(12) Patent Application Publication
(10) Pub. No.: US 2025/0006051 A1
(43) Pub. Date: Jan. 2, 2025

(54) Cam Crusher System

(71) Applicants: Yosef Cohen, Brooklyn, NY (US); Joseph Salem, Brooklyn, NY (US)

(72) Inventors: Yosef Cohen, Brooklyn, NY (US); Joseph Salem, Brooklyn, NY (US)

(21) Appl. No.: 18/762,647

(22) Filed: Jul. 3, 2024

Related U.S. Application Data
(63) Continuation-in-part of application No. 18/443,777, filed on Feb. 16, 2024.

(51) Int. Cl. G08G 1/0967; G06Q 50/00

(52) U.S. Cl. CPC G08G 1/0967; G06Q 50/01

(57) ABSTRACT

The disclosed system comprises parent data storage containing third party data received from a data receiver. The data receiver is configured to receive all type of data and in particular, locations of known traffic hazards and enforcement points that is gathered from official sources for such information and from community contributions of users of the disclosed system. The data receiver is used in pair with data transmitter to send and receive data to and from client devices. The data received from client devices may be comprised of login information, data purchases and community contributions from users of traffic related information. User data comprising traffic traffic information may be manually or automatically configured as private, semi-private or public. Data transmission may include retransmission of private uploads of traffic information from the various client devices, as well as data feed received from official sources towards client devices.

### CROSS-REFERENCE TO RELATED APPLICATIONS

The present application claims benefit of the U.S. Non-Provisional patent application Ser. No. 18/443,777, filed on Feb. 16, 2024, which claims benefit of the U.S. Non-Provisional patent application Ser. No. 18/243,550 filed on Sep. 7, 2023, the complete contents of which are included herein by reference.

### FIELD OF INVENTION

The present invention is related to alert users of roadways regarding the presence of surveillance or law enforcement presence without being a distraction to the driver.

### BACKGROUND OF THE INVENTION

Technological advancements have permitted government authorities and law enforcement to maintain observation of critical infrastructure without being present or seen. Presently this is being done with sensors and video equipment that not only detects activity but is also able to quickly and accurately identify the responsible parties.

The current art lacks the training element, where motorists are conditioned to be aware of the local traffic laws irrespective of whether law enforcement activity is visible. A motorist who is perpetually aware of an ongoing and ceaseless enforcement of traffic laws will be a cautious and law-abiding motorist, and who will eventually be conditioned to naturally follow traffic laws and posted speed limits.

While ongoing technological advancements in traffic monitoring are well intentioned and will provide huge dividends in terms of a safer environment on the thoroughfares, they are often accompanied by little or no public notice. Therefore, the public tends to focus on the punitive aspects of such a system at the expense of the obvious benefits, which undermines the conditioning process. It is therefore highly desirable to provide a system that on the one hand gives the public a measure of predictability and control, by making the enforcement techniques a little more visible.

While similar approaches have been undertaken by other navigation system providers, such as Waze®. However, these systems are at a severe disadvantage when it comes to the use of temporary traffic enforcement measures, and monitoring mounted on vehicles. The existing solutions lack sufficient flexibility to quickly adapt and absorb information taps coming from a slower subscription-based source, and publicly supply materials. With this comes the need to control clutter and provide the ability to filter and exclude traffic enforcement information, that current solutions do not have. Additionally, existing applications constitute significate distraction to the drivers, with directions and alerts appearing on the same screen, promoting clutter and sapping driver's attention away from actual driving. Therefore, by promoting traffic enforcement awareness, the present solutions also increase the hazards of using them when driving.

Therefore, what is required is a monitoring solution that is highly adaptable to ever changing patterns and yet requires no awareness on the part of the driver unless a trap is detected, and at that point, the driver is alerted in an incidental and passing manner that minimizes the hazards of using the alert methods, while maximizing the effectiveness of such method.

### SUMMARY OF THE INVENTION

The present disclosure is designed to raise awareness among the general motorizing public that law enforcement is ensuring that key throughfares and infrastructure areas are being used properly and safely. As a side benefit of the system, users of the system will necessarily need to take proper precautions, including being more attentive and careful drivers, in their efforts to avoid costly citations.

One physical embodiment of the disclosed system comprises parent data storage, which is fed third party data by way of a data receiver. The data receiver is configured to receive all type of data and in particular, locations of known traffic hazards and enforcement points that is gathered from official sources for such information and from community contributions of users of the disclosed system.

The data receiver is used in pair with data transmitter to send and receive data to and from client devices. The data received from client devices may be comprised of login information, data purchases and community contributions from users of traffic related information. The data received from client devices in the form of traffic information contributed by users may be determined by each user of the client device as private, semi-private or public. Data transmission may include retransmission of private uploads of traffic information from the various client devices, as well as data feed received from official sources towards client devices.

Therefore, in one embodiment, data receiver is configured to receive data from a third-party data transmission source, such as an official source of such data, and from at least one client device; and where the data transmitter is configured to send data to the at least one client device.

In another embodiment of the disclosed system contains a source database containing navigational points of interest, as well as attributes of each user of such database. The attributes of each such user would be housed on a client device of such user and comprise of such user's login information, individual configuration parameters of the client device of such user, and navigational points of interest that have been generated by such user using the client device of such user. The disclosed system envisions a plurality of client devices, which, on preference of their users that operate each such client device, are operatively cooperating with each other, which means that they are sharing navigational points of interest, and messages regarding such navigational points of interest with each other. Additionally, such operative cooperation may include participation in groups of common purpose, such as a group united based on class of vehicles (e.g.: trucks, busses, or passenger automobiles), a group operating together based on a common route (e.g.: northbound highway 95 between points “A” and “B”), or a group united by a common purpose, such as a group of motorists employed by or being agents of a single player. In each case of common purpose, the common purpose may dictate, or an administrator of the common purpose may proscribe specific navigational points of interest and/or client device configuration parameters of each member of such common purpose group, which would preferably also utilize common navigational points of interest.

The client device is configured to operate a computer application. The computer application receives data from parent data storage, organizes and manages alerting system for the user of the client device and may have at least two second alert receivers, that receive alerts from the client device. One of the second alert receivers may be one or more client devices of other users that are associated together as a group of friends, acquaintances, collaborative group or social media participants subscribing or being members of a data stream from said social media. The other of the second alert receivers would be a physical alert device that is configured to listen for signals from a client device. The messages sent from the client device to the physical alert device would prompt the physical alert device to emit noticeable, yet unobtrusive, signals that would alert the driver to an impending traffic enforcement zone or another roadway hazard.

The computer application on the client device is preferably configured to calibrate response times dynamically to match a particular type of navigational point of interest together with user preference and/or situational context, such as speed of the vehicle. Some navigational points of interest are configured to track a vehicle within a zone, or are configured to detect a high, low or average operation of a vehicle within a particular sector. For such navigational points of interest, a simple prior warning would be insufficient as user's attention needs to be captivated throughout the ongoing hazard or enforcement window. Equally important is a user's preference on distance of detection. For example, some users will prefer a warning of at least thirty seconds to several minutes prior to entering a sector of enforcement, and further prefer that such interval is consistently maintained irrespective of vehicle's speed or traffic conditions.

The signal emitted by the physical alert device does not require the user to shift attention from ongoing activity of driving, and does not capture driver's gaze, but merely puts the driver on notice. The driver may, when time and conditions permit it, or at the driver's own peril, examine further details about the hazard by querying the computer application on the client device but does not need to do so, and yet will be continuously informed of incoming hazards through quick glance alerting features. The quick glance alerting features are enabled through the physical alert device which works in concert with the computer application running on the client device, comprises an illumination output made up of multiple individual bulbs. These bulbs may be of the same, different, or variable colors. These bulbs will illuminate at different times and stay illuminated or continuously flash for a period of time, depending on what kind of alert has been detected. For example, a full screen illumination that stays lit for a period of time would indicate a speed camera. The illumination would preferably stay lit for as long as the device is covering through the section of the road being monitored by the speed camera. Flashing bulbs would indicate a red-light camera. By adding a colored camera, or flashing only some of the bulbs, would indicate a red-light camera that was shared by another user of the computer application, or communicated to the client device of the user through a community, or a common purpose group. These light signals may be augmented by audio signals as well as colored or illumination affects on the client device, or physical alert device, such illuminating knobs.

In one embodiment, the physical alert device may be used to input navigational points of interest into the software application. The input is usually made with a press of a button or with a sequence of clicks or depressions marking the type of navigational point being referred to, or to identify whether the point of interest is a traffic camera, a speed sensor or whether it is to be classified as a permanent or a temporary input into the onboard storage of the client device or parent data storage. It is preferred that the physical alert device flashes a light signal, for example using the same light emitting device as used in an alert capacity, or a separate light emitting signal, or an audio signal, to confirm that the input has been registered with the software application.

In another embodiment, the software application will detect based on navigational data whether the client device is in an urban or highway setting, and based on this assessment, the input signals being received from the physical alert device are then automatically classified as temporary or permanent database updates, or either stored locally on the client device or further delivered to the parent data storage.

In another embodiment, the physical alert device may emit audio signals that identify traffic enforcement and hazards with particularity, such as “traffic camera in 50 ft,” or “a speed sensor in 100 ft along ABC boulevard.”

The computer application running on the client device is preferably configured to a) be constantly monitoring while in use, and b) preserve battery power in of the battery source of such client device which would necessarily be consumed to perform said monitoring. To this end there may be two processes running, a foreground process, which presents the application screen and displays data of the application wherein said computer application operating on said at least one client instance configured to execute at least one foreground process and at least one background process on a mobile electronic device. The foreground process would be configured to receive data from the parent data storage containing at least one navigational point of attention. In the meantime, the background process would be engaged in monitoring the geographic location and direction of the mobile electronic device on which the software application is running to determine whether the electronic device is in proximity with such point of attention, namely, a speed sensor/camera or a red-light camera, etc. The background process is then configured to send agitational signals to the physical alert device when the location and direction of travel of the mobile device satisfies a proximity condition enforced by the computer application. If the proximity to the point of attention and direction of travel is satisfied, the software application signals to the physical alert device to alert the user (the driver) that an attention point has been detected. For example, the user would then check their speed or surroundings to determine that no hazard is present and to ensure that the user is otherwise following all applicable traffic rules. The proximity condition, and the subsequent alerting, continues until users have traveled outside the detecting zone of a particular point of attention. The physical alert device is configured to produce an audio or visual signal on receiving the agitational signal from the background process. In an alternative embodiment the functions of the foreground and background processes may be reversed or otherwise different, or there may be additional or fewer processes handing the tasks described in this application.

In another embodiment, the physical alert device may be self-contained device that receives a map of hazards from a central location or a common purpose group, or community.

In another embodiment the computer application with assistance of onboard camera equipment may dynamically capture images of road hazards and using artificial intelligence interpret the type and purpose of such hazards. Once recognized as hazards, the computer application will then store the hazards for alerting on the local client device, which may or may not be shared with a community or group of common purpose.

### BRIEF DESCRIPTION OF DRAWINGS

FIG. 1 is a high-level diagram of the overall effectiveness of the disclosed system in delivering information to a lot of users, creating a system of multiple sources of information.

FIG. 2 is a diagram of the basic flow of data.

FIG. 3 describes the flow of data among users of the disclosed system and devices.

FIG. 3A is a diagram describing an embodiment having connectivity with an Entertainment or navigational systems of a vehicle.

FIG. 3B is a diagram describing the software's application usage of short message functions.

FIG. 3C is a diagram showing a dataset of data.

FIGS. 3D and 3E are additional software application diagrams.

FIGS. 4 and 5 describe the basic operation of the alert system.

FIG. 6 describes one instrumentation embodiment enabling the disclosed system.

FIGS. 7 and 8 are screen representations of the foreground process and the function of the client device as a traffic enforcement and hazard alert system and as a navigational tool.

FIGS. 8 and 9 show one embodiment of the physical alert device.

FIGS. 9A, 9B, 9C, 9D are various diagrams showing the physical alert device.

FIG. 9E is an additional embodiment of the physical alert device.

FIGS. 10 and 10A are contextual diagrams showing the physical alert device.

FIG. 10B is a diagram of an interior of a vehicle showing additional equipment of the disclosed system that has been integrated into vehicle circuitry, added to steering wheel or which may be added to vehicle infotainment system.

FIG. 11 is a diagram demonstrating various alerting possibilities.

FIGS. 11A-11C demonstrate several screens of a user interface enabled by the present invention.

FIG. 12 is a contextual diagram demonstrating some of the possible alerting conflicts.

FIG. 13 is a diagram of an alternative embodiment whereby the disclosed software application detects navigational points of interest using artificial intelligence with help of optical or sonar equipment.

FIG. 14 demonstrates some of the possible navigational hazards, showing two directional cameras of average speed camera.

FIG. 15 shows the various community wide monitoring preferences.

FIG. 16 is a diagram demonstrating a battery saving feature of the software application demonstrating the ability to shut down when monitoring is not desired or certain preconfigured condition is not true.

FIG. 17 is a diagram of an alternative embodiment, demonstrating client devices and physical alert devices functioning independently as well as introduction of a management process.

FIG. 18 demonstrates one embodiment of a configuration screen demonstrating a menu for configuring alerting parameters.

FIG. 19 is a diagram interaction between the disclosed software application and sensor devices mounted on public transport vehicles.

FIG. 20 demonstrates alerting in view of detected public transport vehicle.

### DETAILED DESCRIPTION OF THE INVENTION

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Disclosed in the figures is an alert system comprising a parent data storage 10. Parent data storage 10 preferably comprises a parent application component 13 and parent database 12. The parent application component 13 is responsible for managing subscriptions to the data stored within the data storage 10 and for managing user accounts of the disclosed system. The parent application component 13 is also responsible for receiving data received from client devices 30 and for parsing such data into user private data, user shared data and user generated information intended for the general public. The parent application component 13 is further responsible for synchronizing the durability terms of some data across the parent database 13 and data storage local to the client devices 30. Enforcing durability terms is important to control informational clutter and to ensure that the disclosed system can adapt to the changing enforcement and hazard landscape. In one example durability is enforced by the parent application component 13, which determines which hazard has been identified and added and by whom. For example, a major collision or road work/closure may automatically receive a temporary durability rating, whereas a camera sensor configured to measure speed or rolling through stop-sign violations would be more permanent in nature. Alternatively, durability can be configured at each client device 30, with or without the ability to be overridden by the parent application component 13. The client device 30 may additionally be configured to determine durability based on context. For example, based on the type of hazard reported or the customary of whether the reporting or visiting user is within his or her common travel area.

Database 12 is configured to receive data from third party official sources of data 5 which may be government or law enforcement databases. This data is then sent by the parent software process 13 to at least one client device 30. Preferably there may be a plurality of client devices 30a subscribing to the data from the database 12. This data is stored locally on each client device 30 or 30a. Additionally, a user of each client device 30 is able to populate the computer application 60 with additional enforcement or hazard data, which may then be shared directly by the computer application 60 on the device where such data has been initially entered with communities 50 and sub-communities 51 of client devices 30a, which may collaboratively assist each other in keeping track of ever-changing enforcement features. Each client device 30 from a plurality of client devices 30a would each accommodate user input occurring on each such device. The user input a navigational point of attention, which may be one of, but is not limited to, a recording of a roadway hazard comprising one or combination of a speed camera, red light camera, stop sign camera, roadwork, construction, road closure, accident, traffic jam, etc. The computer application instance (60) executing on each of the client devices 30 can be configured to automatically share some or all of the hazards of other client devices 30a in a group or local area of client devices 30, or may be configured to share user entries either based on the particular hazard being identified by a user, through the settings of the application on that client device 30, or at discretion of the user each time the entry is made.

The software application instance 60 on any client device 30 may contain at least one second alert recipient. One of the second alert recipients may be another software application 60a on a remote client device 30a. A remote client device 30a is preferably another one of the recipients of the parent data storage 10 but would represent a remote client device for a peer client device 30 that is publishing a user entry. As mentioned above, the publication of a user entered navigational point of attention from one client device 30 to or from a peer client device 30 may occur automatically based on a group or participation criteria or a hazard type, based on a configurable setting of the publisher or recipient or based on a one-time determination of the publisher or subscriber. A user of the remote client device 30a is also able to manually enter navigational point of attention for its own benefit, and/or to be uploaded to the parent data storage 10 for public benefit, or to be shared with other client devices 30 and 30a. Another secondary alert recipient is the physical alert device 40. The physical alert device 40 serves as the alert recipient to alert the user within the immediate physical vicinity of the physical alert device 40 of an approaching navigational point of interest through an audio or visual, or light signal. The physical alert device 40 is also the instrumentation that enables input of the navigational points of interest into the application instance 60 on the client device 30 that is physically proximate to the physical alert device 40, with said input eventually being reflected on per client devices 30 or within the parent data storage 10.

A user may add navigational points of attention using the screen 60b or input keys of a client device 30. A user may also use the physical alert device 40 to add navigation points of attention at the press of a button, without taking eyes of the road or traffic conditions. The data added in such manner may be deemed to be temporary or permanent data to be stored on the client device only or it may be temporary or permanent data to be shared with the parent data source 10. Any data added by a user using either the client device 30 or the physical alert device 40 may be removed by a user in the same manner, using a delete function or a sequence of button clicks on the physical alert device 40 that would translate to a removal.

The software application 40 on each client device 30 subscribes to parent data storage 10 to be able to receive at least one navigational point of attention (10a). The navigational point of attention may include, but is not limited to, a traffic camera, a speed sensor, a police sentinel, a road condition, a construction condition, an accident, a weather hazard, a mob hazard, or any hazardous condition. The parent data storage 10 may also provide navigational data to each client device or such data may be stored locally on each client device. A user may add such navigational points of attention by hitting to input keys 110 on the physical alert device 40 when the client device 30 is within several dozen or several hundred meters from the navigational point, at the spot of the navigational point of attention, or departing from the navigational point of attention. A sequence of clicks, or a selection choice of navigational points to be added on the screen or a particular button would determine the navigational point of attention that would be displayed on the application running on the client device 30 or on client devices 30a associated with the inputting device by a common parent data source 10, data sharing among devices or a social media feed.

The software application 60 on the client device 30 is then calibrated use geo-positioning to determine whether the client device 30 is traveling toward a navigational point of attention, and if so whether the direction or path of this travel is vectored to intersect with such navigational point of attention. If the condition of travel and intersection satisfies a proximity condition enforced by the software application 60, the software application will dispatch an agitational signal to the physical alert device 40 which will emit an audio or visual signal alerting the user, who may be a driver of a vehicle where the client device 30 is present, of an approaching navigational point of attention.

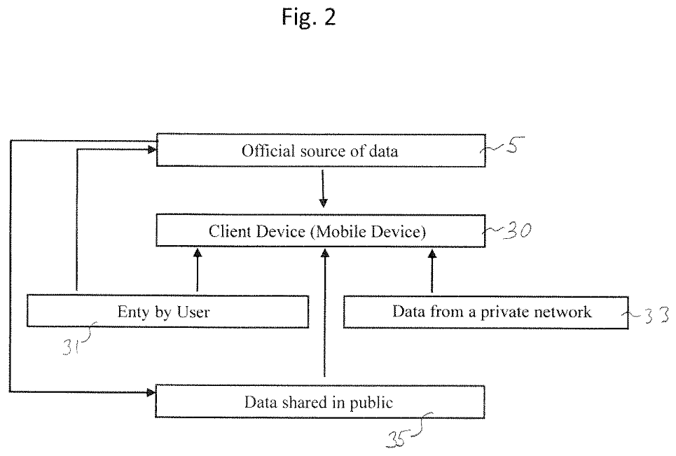

FIG. 2 demonstrates the various sources of data utilized by the software application 60 executing on a client device 30. The primary source of data sets the is official source of data 5 from the parent data storage 10. Some data sets may be entered by the user of the client device 30. For example, the user entry may include a user's local traffic camera or a vehicle-mounted sensor that will be present within proximity to the user area for some short period of time. The user may configure a privacy and duration setting, to determine whether such data should be shared on a private network 33. A private network may be a direct communication with an associate client device 30 or information received from a social media feed where an associated client device 30 may be publishing data or using said social media feed to upload information directly to a navigational point of attention to an associated client device 30. Some data may be received from unassociated client devices or other third-party sources via a public source 35. All such data may be uploaded to a parent data storage 10 to serve as a data backup for the uploading client device 30 and as means of data dissemination, in which case, it is preferable that the parent software process 13 will distinguish between private data, data shared only with client devices associated with the uploading client device 30 and data obtained from the public. It is preferred that the parent software process 13 will also maintain the duration of certain data sets, to gradually delete stale or outdated information.

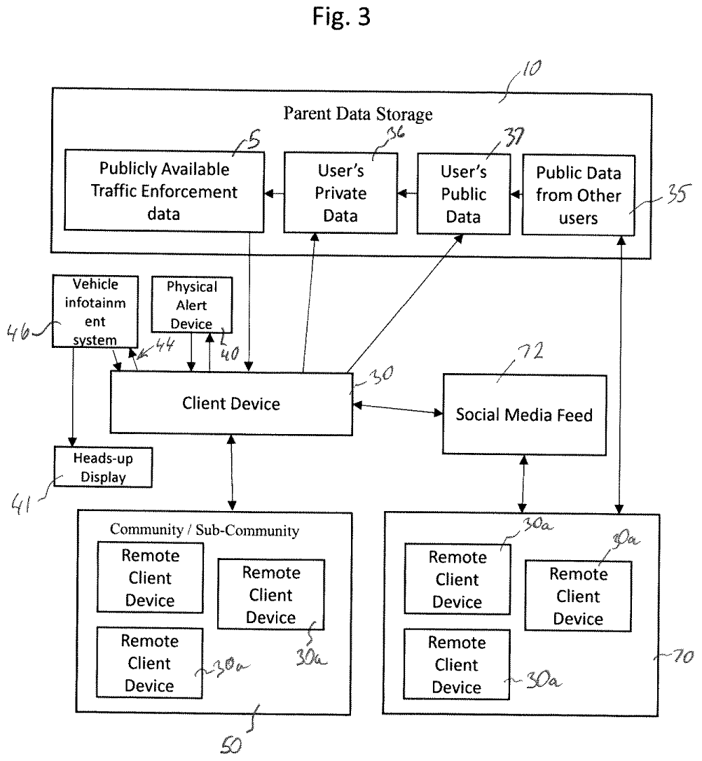

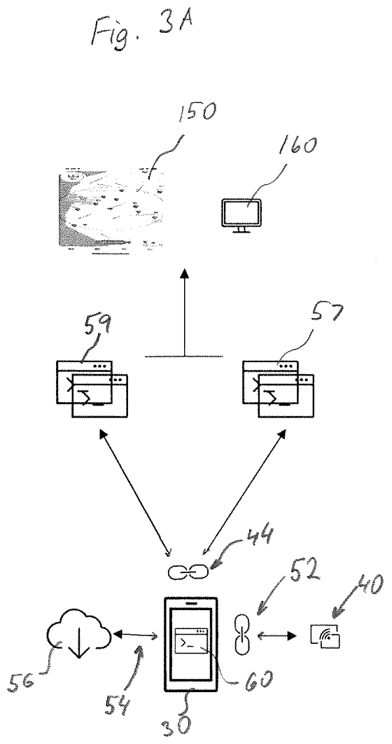

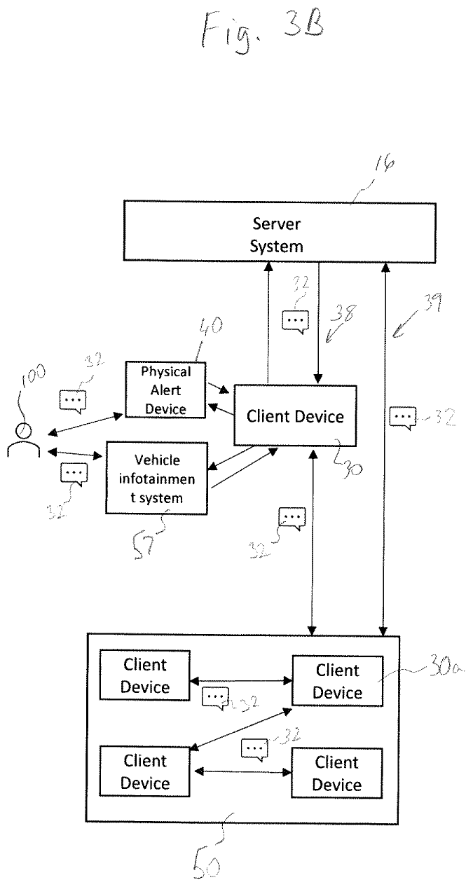

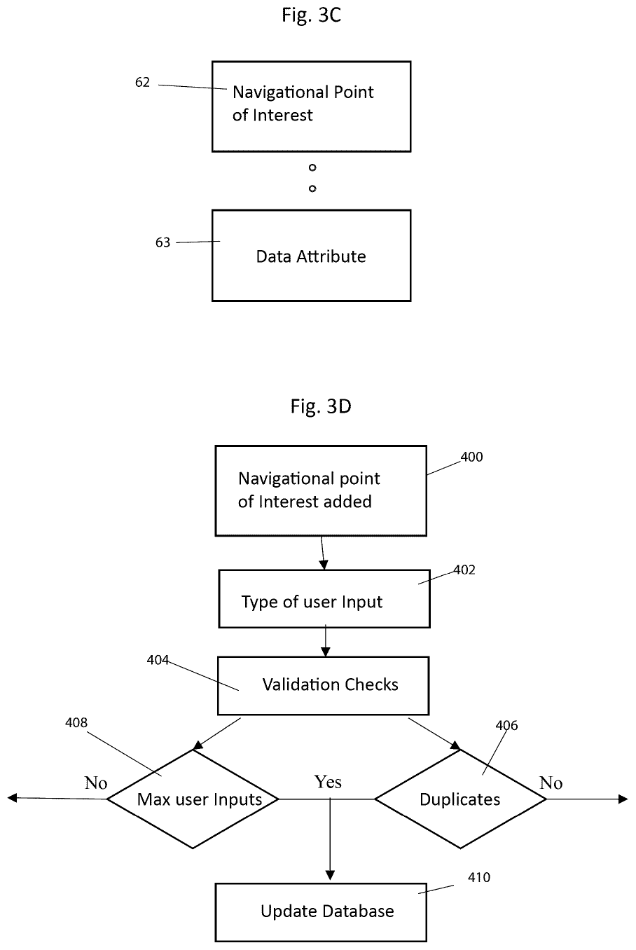

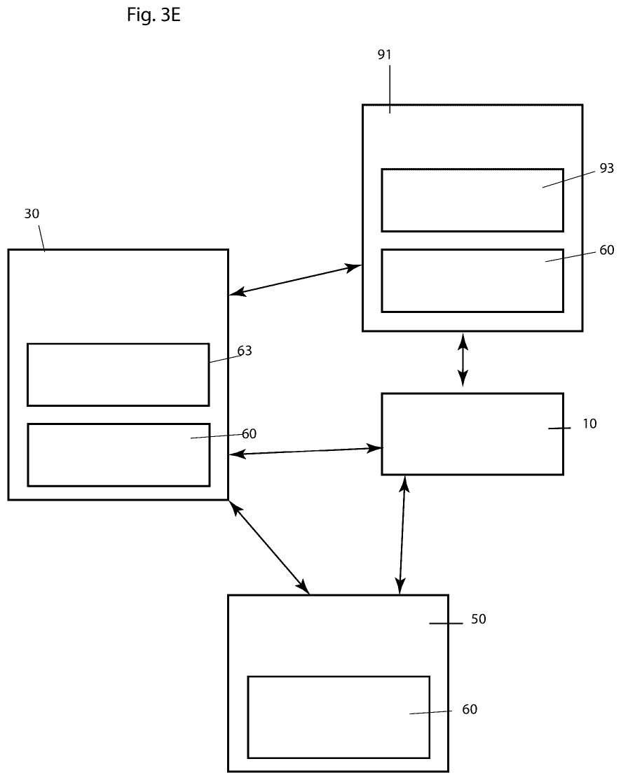

FIG. 3 further demonstrates all of the sources of data sets and their flow within the disclosed system. The client device 30 receives navigational points of attention, namely, traffic hazards, traffic enforcement and traffic condition data, or any other types of data, from the publicly or commercially available data storage 5. The user of the client device must create an account, or the account may be created automatically when a user of the client devices 30 purchases the software application 60 and downloads it from the parent data storage 10. The user's account and private information, such as billing information, or user's navigational entries classified as private, are then stored on user's private data 36, and stored first at the local storage of the client device 30 and then uploaded to the parent data storage 10 for data backup. A user may wish to share some navigational points of attention with other associated devices either directly to a community or sub-community 50 or associated/remote client devices 30a, or via social media feed 72 to the remote client devices 30a. It should be appreciated that remote or associated client devices both within a community 50 or subscribing to a social media feed 70 may themselves upload user public data, which for any particular subscribing client device 30 becomes a public data from other users. The client device 30 would be sending alert signals to the proximately located physical alert device 40, which would alert the user or driver of an upcoming traffic monitoring device or feature representing a navigational point of attention. At the same time, a user may utilize the physical alert device 40 to add or remove a navigational point of attention, which input being limited to the client device 30, or propagated to remote client device 30a.

In another embodiment the client device may contain a secondary channel or further demonstrates a supplementary communication function 44 of the client device 30. The supplemental communication function 44 may be used to connect to an infotainment system of the vehicle where the user is present, while simultaneously connecting to a physical alert device 40. Alternatively, either the supplementary communication 44 or the physical alert device 40 may be used, or both the supplementary communication 44 and the connection to the physical alert device 30 may be enabled on the client device 30 and ready to connect. In this manner either the vehicle's onboard infotainment system or the physical alert device 40 can be used to alert the user of a traffic feature requiring user's attention. The supplemental communication function 44 may be enabled by having the software application enabling a secondary radio communication channel having a different frequency or a different channel identifier. The supplementary communication function 44 may enable the client device 30 to connect to additional or other local devices without interference from the physical alert device 30.

The software application 60 may potentially create at least three communication instances. Shown in FIG. 3A is a basic connectivity topology of the disclosed cam crusher system. The client device 30 having the software application 60 may create a primary radio channel connection 52 for communications between the client device 30 and the physical alert device 40. Additionally, the software application 60 may be configured to connected with an application programing interface of a vehicle's entertainment system 57 or vehicles navigation system 59 (if entertainment and navigation systems are separate) or one common vehicle system. Such connectivity may be achieved through a separate supplementary communication function 44, which may be an additional radio transmission channel, or which may be a toggle between a radio transmission channel and a wired connection into a vehicle's circuitry. The vehicle's entertainment system 57 and/or the navigation system 59 will then produce an alert similar to the one generated by the physical alert device 40, or may integrate alerting with standard navigation features, while also displaying various navigational points of interest uploaded into the vehicle's entertainment system 57 and/or the navigation system 59 by the software application 60. A third radio connection utilized by the software application 60 is the internet interface 54 to the internet 56, which is used to send and receive messages to and from the parent data storage 10, client device communities (50) or social media and internet feeds (72 and 70).

FIG. 3B demonstrates the function of the software application (60) which allows users of the software application 60 executing on client devices 30 to communicate with other users of the software application, using coordinates of the client devices 30 that are nearby, or which are in the community or user group 50 together with the client device 30. The communication functionality permits users to send audio or text messages 32 to each other or to the entire group 50. Preferably a user 100 would utilize a voice activated command to initiate a voice memo 32 by speaking to the physical alert device 40 or to the client device 30 directly, or to the infotainment system 57 of the vehicle where the user 100 is presently located. A typical command may be initiated with signal phrase “Hey Cam Crusher . . . ”; followed by a command, for example, “send a message to . . . ,” or “reply to . . . ,” and then the target device or group. A different or alternative audio command structure may be utilized to enable hands free operation of the features supported by the software application (60). The same commands and communication may be keyed in by the user 100 at the client device 30. The software application (60) may then share the message memo 32 through a central server 16, which may also be running the parent database 10, or the client device 30 may communicate directly with other client devices 30a using coordinates, telephone numbers of those devices, or address information, including group affiliation, directly to the instances of the software application (60) executing on the client devices 30a.

Additionally, it is preferable that the software application (60) is configured to detect the strength of a cellular network signal and may trigger additional downloads or uploads of data or messages 32 to or from parent database 10 or other client devices 30a.

FIG. 3C further demonstrates a dataset 67, a plurality of which comprise the data of the database stored locally by the software application 60 on a client device 30 or stored centrally on a parent database 10. Each dataset 62 is preferably comprised of a navigational point of interest, such as a speed camera, traffic light camera, stop sign camera or a noise decibel sensor. Additionally, each navigational point of interest may be qualified with an automatic attribute 63, which may be a configurable item by a user who entered the navigational point of interest. The attribute will determine whether the navigational point of interest is permanent or temporary, private or shared, as well as the presentment of the color of the screen icon (80, 84, 85) that identify the navigational point of interest on the screen of the client device 30, or on the projection display 150.

FIG. 3D demonstrates the steps taken by the software application 60 that serve to update the onboard database of the remote client device 30 and/or the parent database 10. In step 400 the client adds a navigational point of interest using a physical alert device 40, the client device 30, or keys and voice entries on vehicle's infotainment system or vehicle's instrument panel (211, 212). Each entry is then verified in step 402 for validation 404, validation 404 may include, but is not limited to determining that the user has not exceeded his/her update limit 408. An update limit is set to avoid cluttering the system and avoid bogus entries, for example if a child is playing with a particular client device 30. The software application 60 also checks for duplicates in step 406, to prevent too many users alerting to a publicly published navigational point of interest. It is preferred that the validation steps are done locally and verified against the parent database 10 or the peer group 50 of the client device 30.

Described in FIG. 3E is the interplay between the client device 30 and the software application 60 running on the client device 30. The software application 60 interacts with other systems 63 that may be running on the client device 30 or the vehicle operating system 91. Some of the of the other system 63 that may be required to interact with the software application 60 are the global positioning components and navigational components, time components and connections to physical alert devices, such as the alert device 40, or the alert functions of the vehicle 91. All interactions occur locally at the client level 30 or at the vehicle level 91 or may be migrated across the vehicle 91, client device 30 or social network 50, all of which may update or be updated by the parent database 10. Features of the software application 60 that benefit from this interaction is a) an alert time delay feature and b) application only feature. The time delay feature is configured to detect when the device on which the software application 60 is running has stopped in proximity to a navigational point of interest. Usually this means that the vehicle or person has stopped moving and is waiting at a red light or is stuck in traffic. The time delay disables alerting for a period of time, or at least until the user or vehicle begins moving again. The application only feature detects when the software application 60 has no secondary alert device, such as a vehicle or a physical alert device 40, and it is able to alert using just the features available on the device, such as the speaker, illumination, light flashing or vibrations.

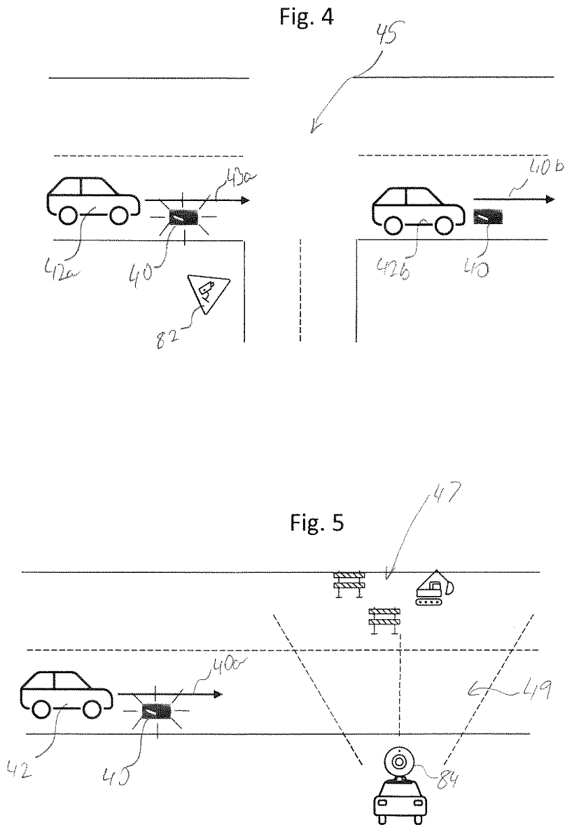

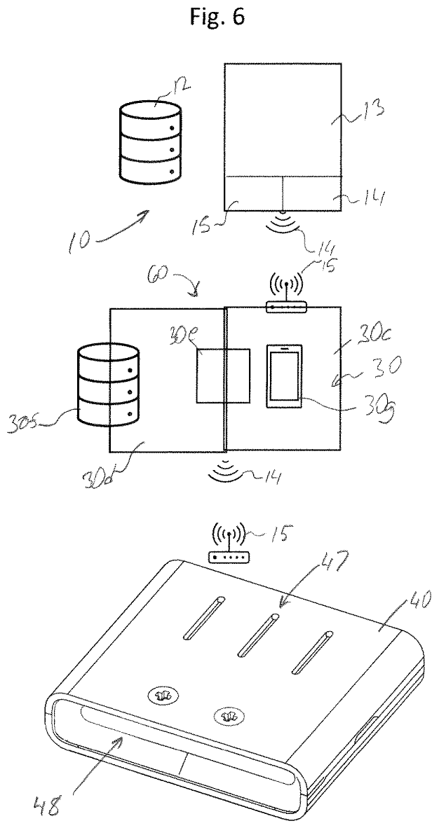

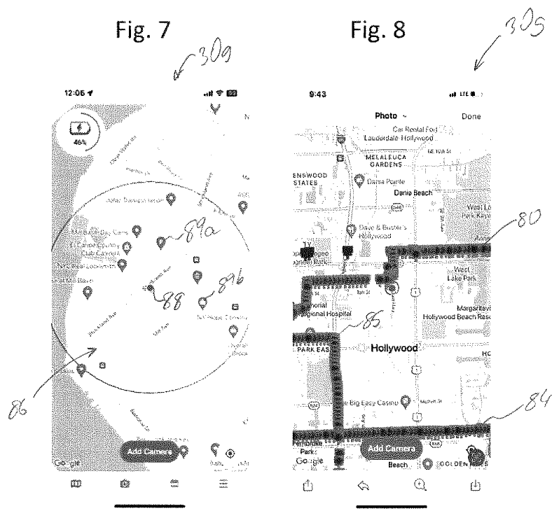

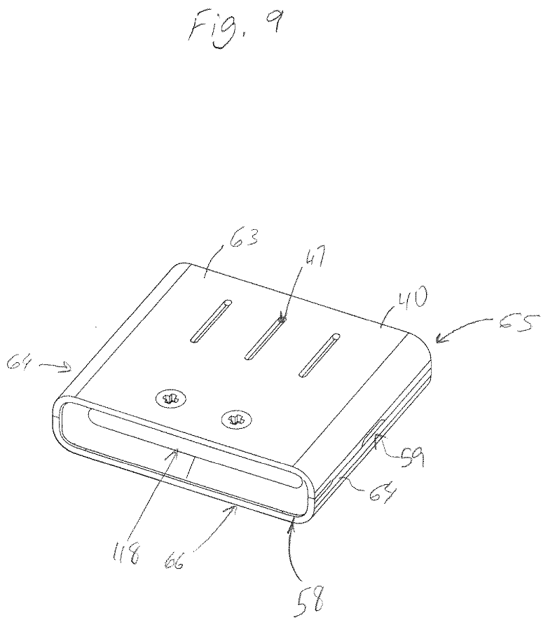

FIGS. 4 and 5 demonstrate the primary operation of the disclosed system. In FIG. 4, the navigational point of interest is traffic camera 82, which may be monitoring speed and/or compliance with traffic rules and signals, such as traffic light and stop sign. The initial information regarding the traffic camera 82 may have been received from parent data storage 10 or previously saved by the user via user entry using the software application 60 running on the client device 30 or by using the signal keys 110 or voice activation features of the physical alert device 40. Demonstrated in FIG. 4 is an instance where the software application 60 identifies the direction of travel 43a as vectored to intersect the enforcement area 45 of the traffic camera 82. Therefore, the software application 60 will dispatch an agitational signal to the physical alert device 40 when the vehicle 42a, carrying the client device 30 is in preset proximity to the traffic camera 82, which may be determined based on certain distance to the traffic camera 82. On the contrary, the vehicle 42b is moving away from camera 82, therefore the physical alert device 40 on board the vehicle 42b will remain dormant. It should be noted that sensor driven navigational points of attention, like the camera 82, or any other type of sensor, may still be capable of detecting non-compliant activity after a vehicle exists the immediate monitoring area of such a camera. Therefore, it is preferred that the software application 60 will continue to issue until the vehicle is well out of effective range that is on such sensor. This range of detection both on approach to the navigational point of attention and when departing or traveling away from it can be a configurable feature of the software application 60 executing on the client device 30 that is being utilized by the user (100). It should be noted further that all configurable parameters are preferably transferred by the software application 40 to the parent database 10 for each client device 30 to serve as a remote backup of user settings and configurations.

Additionally, as illustrated in FIG. 5A, the distance may be set in proportion to the ‘of travel. For example, a warning signal within 100 feet of the navigational point of attention may be a sufficient warning for a slow-moving vehicle. This distance would need to increase to hundreds of feet or several miles for a vehicle traveling at highway speeds. The software application is preferably configured to calibrate issued alerts based on speed of the vehicle such that an alert is received in proportion to the time it takes to comply with the approaching navigational point of attention, for example to slow down, or lower the volume of onboard sound system. Shown in FIG. 5A is internal processing that may take place within software application 60, where a navigational point of interest is detected based on stored data of such points and vectored with the location and direction of travel. The software application 60 will then identify an appropriate distance required by a user and the vehicle to react to such point of interest. For example, a vehicle traveling at highway speeds will reach a navigational point of interest much faster than a slow-moving vehicle, therefore an alert must be calibrated to give a user sufficient notice depending on the user's speed of travel.

The alert projected by the physical alert device 40 is preferably determined in part based on the type of navigational point of interest being encountered. Therefore, an alert for a red-light camera 82 would be sounded when the client device 30 is approaching the camera, or in the immediate zone of coverage by the camera. On the other hand, a mobile enforcement unit (84) or a speed camera/sensor would continue alerting after the client device 30 has passed or is moving away from the sensor for some distance. This is the preferred calibration of the software application since some sensors continue to monitor and potentially lead to a citation even after a vehicle has left the immediate target zone. Depending on the specific navigational point of interest entered by a user using the client device 30, or the keys (110) on the physical alert device 40, the software application (60) would calibrate the duration or type of alarm to sound. For example, in an embodiment where the screen 48 of the alert device 40 is made of multiple LED lights a signal of a particular color or sequence of particular bulbs can indicate a red light camera, a different color or light sequence will indicate an approaching speed zone, yet a different color or light sequence will be indicative or an approaching accident, traffic or a noise decibel enforcement sensor. Alternatively, or additionally, alerts may be accompanied by an audio message played through the client device 30, the alert device 40 or the infotainment system (57) of the vehicle where the client device 30 and the physical alert device 40 are located. Alerts may indicate “approaching noise describe monitoring area, consider next left as an alternative route,” or “approaching a speed monitoring zone, consider slowing down.” The software application 60 is configured to serve as an alert device and to suggest potential alternative routes or corrective actions to avoid being cited by the monitoring sensors.

FIG. 5 demonstrates additional data that may be monitored by the software application 60. Shown is a vehicle 42 carrying the software application 60 running on a client device 30. The direction of travel 40a is vectored to intersect with at least one navigational point of interest that may be stored on the parent data source 10, namely, a construction zone 47 and a mobile traffic enforcement unit 84. Due to its nature, the mobile enforcement unit 84 will be classified by the software application 60 as a temporary navigational point of interest. While the mobile enforcement unit 84 will be uploaded to parent data storage as part of user's public data 37 and presented to other users by the parent data storage 10 as public data from other users 35, both the local software application 60 and the parent data storage 10 will be phase out or delete the mobile enforcement unit 84 within several hours or several days, depending on software configuration. Additionally, it is preferred that in the event that a mobile enforcement unit 84 has been added by another user for another client device 30a, that the parent data storage 10 and/or the software application 60 on the client device 30 is configured with requisite logic to inform a user attempting to add the same mobile enforcement unit 84 to the software application 60 that this mobile enforcement unit 84 is already present and the entry will be ignored, unless the entry is for a different or changed mobile enforcement unit 84.

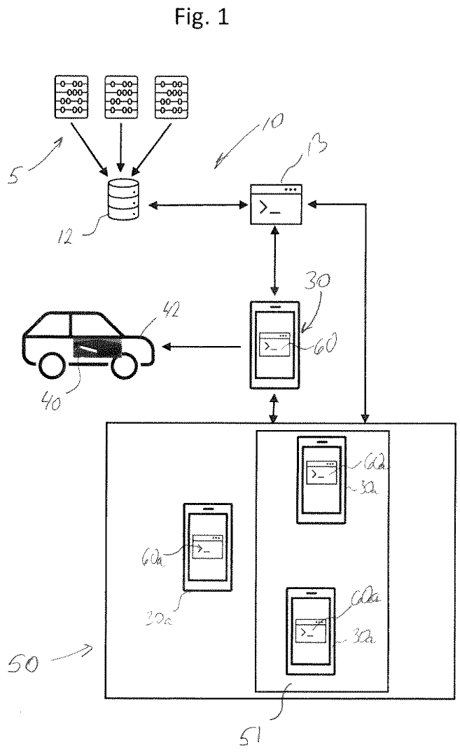

FIG. 6 demonstrates one embodiment of the disclosed system. Disclosed is the parent software process 13 and database 10 representing the parent data storage 10. The parent data storage 10 has a receiver process 15 and sender 14 to communicate with a third-party source of data 5 (FIG. 1) or with at least one client device 30.

The client device 30 may be comprised of a foreground process 30c connecting to a background process 30d through a bridge process 30e and containing a local data storage 30f. A receiver process 15 and sender process 14 interacts with the parent data storage 10 to send and receive navigational points of attention and further interacts with an alert device 40 to generate an alert via an onboard audio signal 47 or visual signal 48. The alert signal may be generated on the device 30g if the connection with the physical alert device 40 cannot be established. The foreground process 30c may be charged with parsing data sets received from the receiver process 15 and directing user entries to the remote recipients, such as the parent data storage 10 or a remote client device 30a, via the sender process 14. The background process 30d may manage ongoing monitoring of direction and speed of trave and location of the client device 30 against navigational points of attention stored on the local data storage 30f that is continuously being populated by the foreground process 30c with data sets from the parent data storage 10 and user entries. The foreground process 30c is also used to display navigational data and details on navigational points of interest and alerts on the screen of the client device 30g that is operating the client application 60. The software application may also comprise just one process capable of carrying out multiple tasks, or a plurality of processes, some of which may operate in the background and some in the foreground, of which some may have limited function or varied function. Alternatively, the roles of the background process 30d and the foreground process 30c may be reversed, or may otherwise be different, or there may be additional or fewer separated processes enabling the functionality of the software application 60.

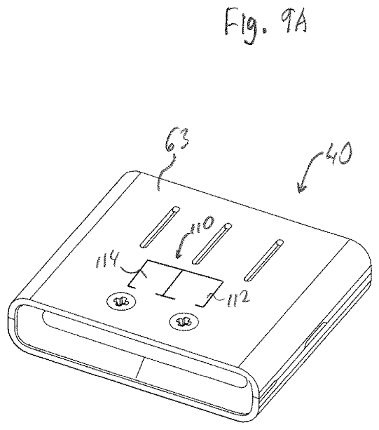

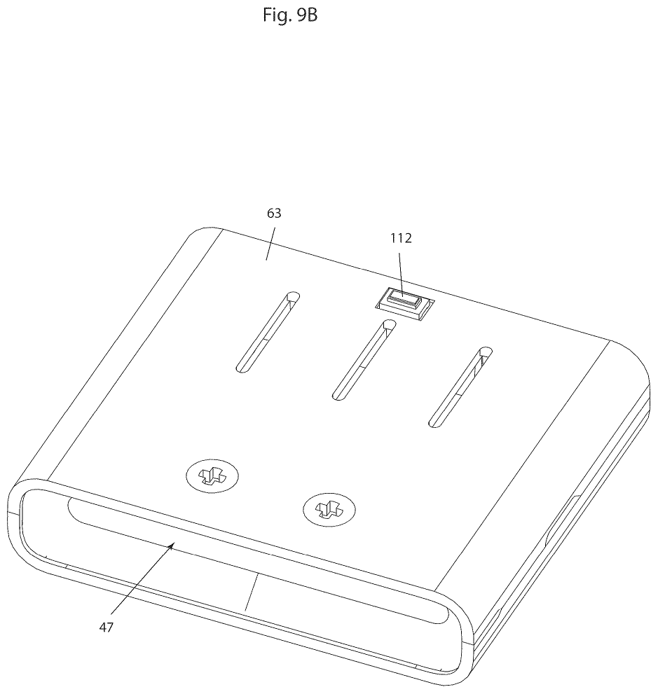

FIGS. 7 and 8 demonstrate the software application screen 30g. FIG. 7 demonstrates one screen embodiment showing both navigational data and proximity data 86 showing various navigational points of attention 89a and 89b within the requested proximity 86. It is preferred that the screen may be equipped with a daylight feature, that would display the navigational data and screen icons (80,84,85) showing navigations points of attention in colors more natural or noticeable during daylight level at that time, with different background and icon colors during the night. This feature may be enabled automatically or manually through the software application's settings screen.

FIG. 8 demonstrates a plurality of navigational points of attention 80, 84 and 85. The user may enter as many or as few navigational points of attention. Some of the navigational points of attention may be supplied via official or commercial sources (5) and represent relatively permanent traffic enforcement or hazard locations. Other navigational points of attention may be unique or private to the particular screen 30g being viewed, having been entered as a user's private information. In one embodiment, each of the navigational points of attention 80, 84, or 85 are color coded based on particular point of attention represented, so that a user may tell at a glance what point of attention the vehicle is approaching or the source of the point of attention. For example, a red-light camera 84 may be represented by a red flag, while a speed camera sensor 80 may be represented by an orange flag. Additionally, if the red-light camera 84 was loaded using a parent database 10 it may have a color coded outline or frame that indicates that it came from a parent database 10 and thus most likely represents a permanent fixture. On the other hand, a speed sensor on a highway entered by a passing user may have a different colored outline or a frame of a different color or shape that would indicate a user entry, or a temporary entry. The software application 60 of the device that received the user entry may determine automatically whether the entry is short term, long term or permanent based on factors such as the type of navigational point of interest entered, the time of day, the speed of the vehicle, the response from other users, etc. The term and/or color of each navigational point of interest will then be communicated to the parent database 10 or to at least one other client device 30 and represented on the receiver device with accurate term and color of the inputting device. Other points of attention may have been shared via community (50) or social media/internet feed (72, 70) from other client devices (30a).

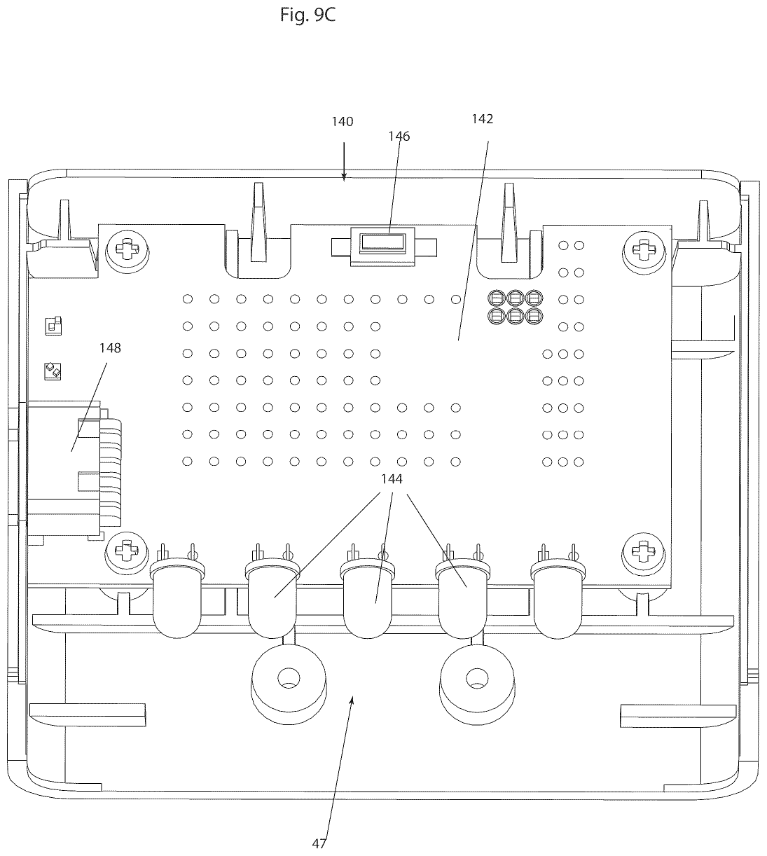

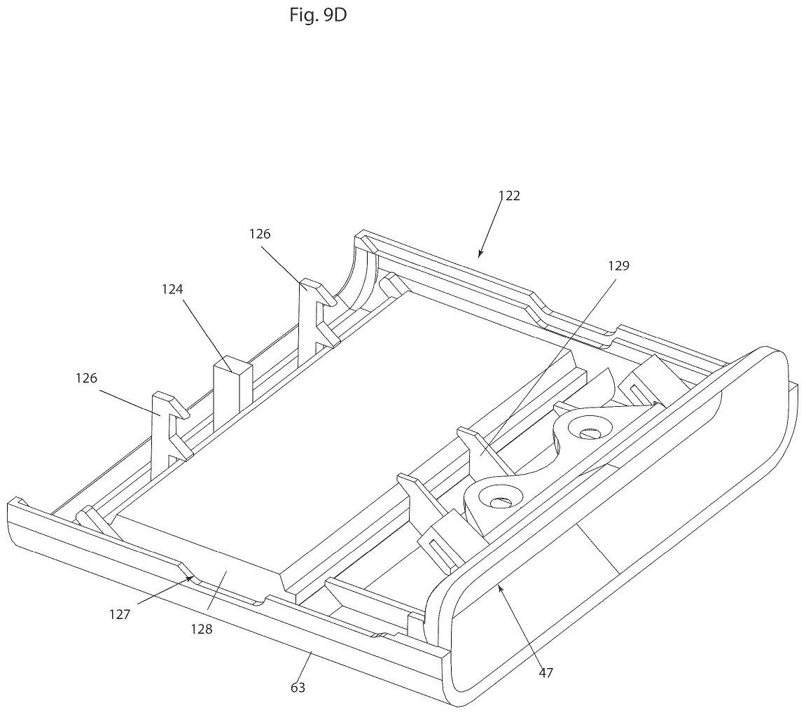

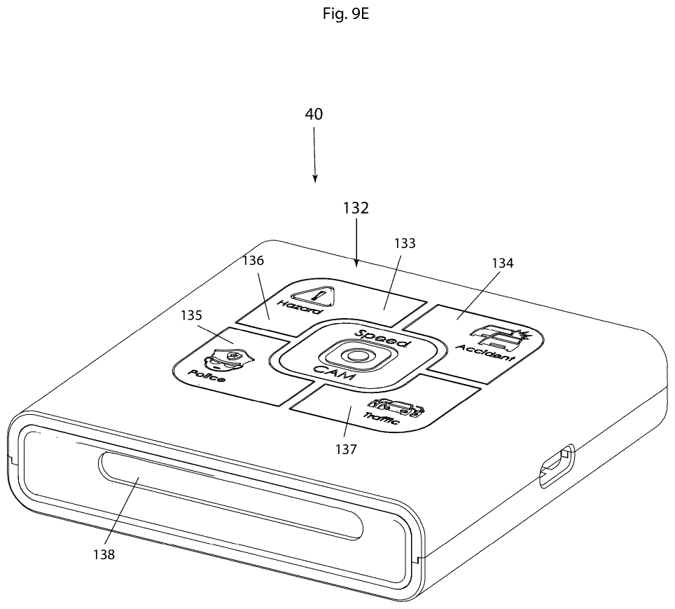

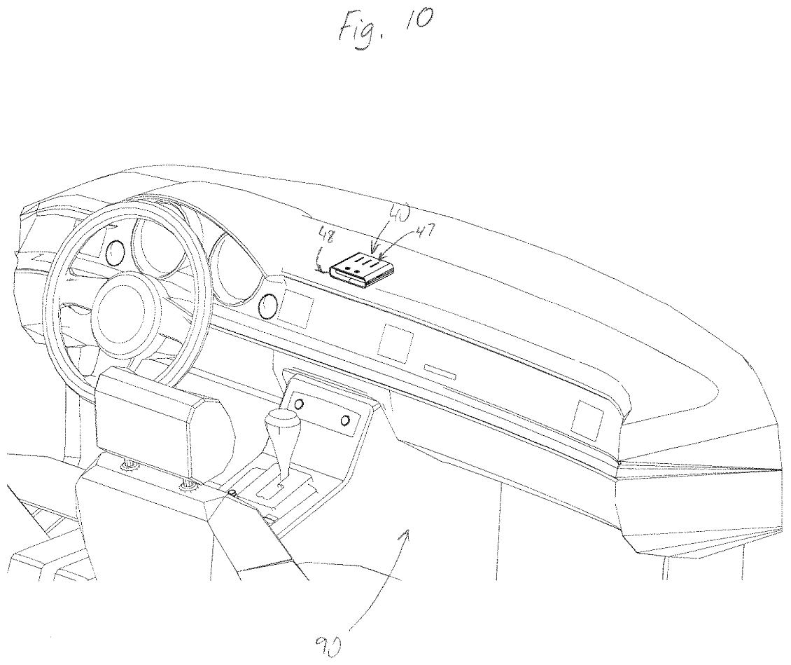

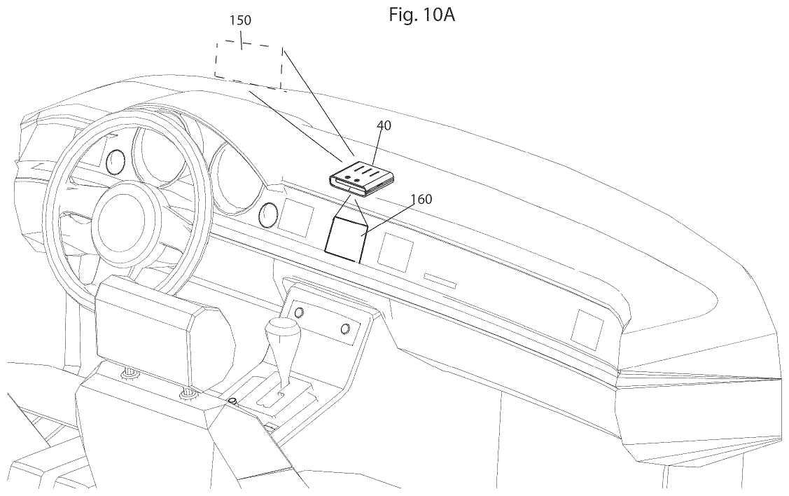

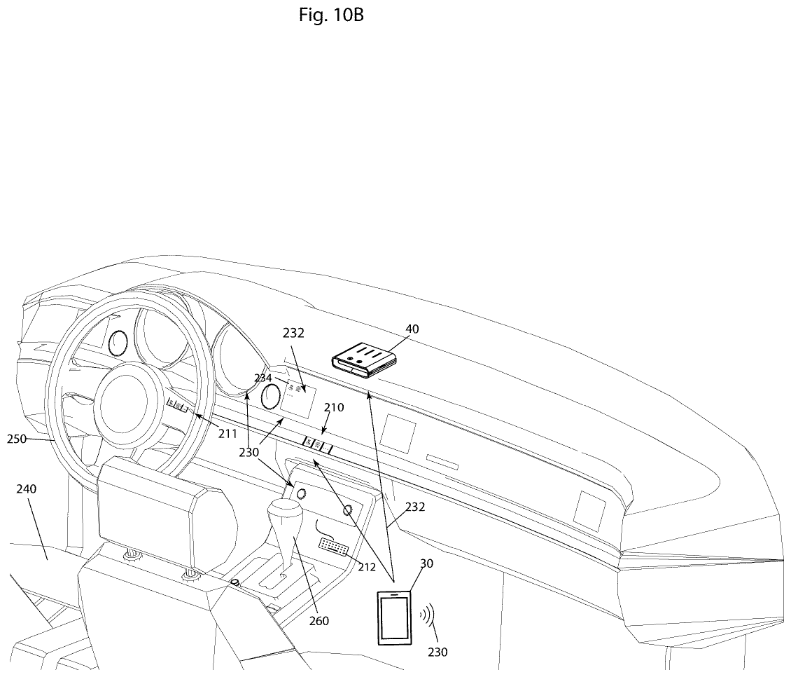

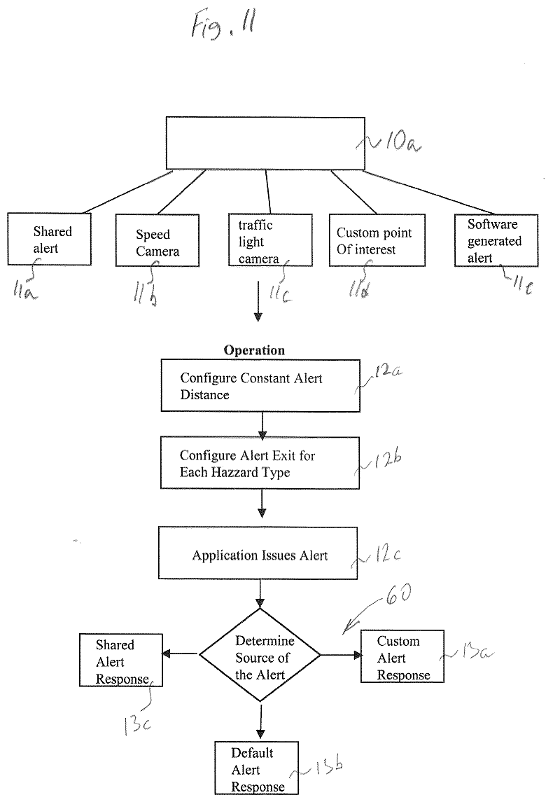

FIGS. 9 and 10 demonstrate a physical alert device 40. The physical alert device 40 preferably contains a data or signal receiver (15) that may receive communication from a background process 30d from a software application 60 in close proximity to the physical alert device 40. The physical alert device 40 preferably contains an onboard power source that may be replaceable or rechargeable via port 59. The physical alert device 40 may additional be powered directly from an external circuitry, such as the vehicle power system by utilizing a universal serial port connection, a power port connection, or a cigarette lighter port connection. Physical alert device 40 may additionally be equipped with an onboard coil element for proximity charging. The physical alert device is configured to emit a warning signal on receiving an agitational signal from a proximate software application 40. The warning or alert signal may be a light alert signal coming via the screen 48, which may be a simple flashing or steady light emitting diode, or which may display additional information using a liquid crystal display. Preferably the alert signal may instead or additionally issue from an onboard audio speaker 47, which may be a chime, a sharp strike, or a siren, or an audio message such as “mobile enforcement device 200 feet ahead,” or “speed sensing radar one mile.”

FIG. 9 demonstrates the alert device 40 that is shaped as a parallelogrammical cube having a top wall 63 a bottom wall 59, sidewalls 64, a back wall 65 and a front wall 66 being placed on the dashboard 90 of a vehicle's interior. The physical alert device 40 may also be shaped as a cylinder, a sphere, a pyramid, or any other three-dimensional geometric shape. At least one or more of the walls may contain mounting means, such as hooking device, an adhesive strip, a hook and loop or snap two-part connector or a magnetic connector. The placement of the device need not be in front of the driver as the alerting flashing and sound can be heard from general proximity of the vehicle's interior, and furthermore, driver need not shift his/her attention to the device for the alert to be effective. The physical alert device may be rechargeable or connected to on board power source.

In one embodiment shown in FIG. 9A, a user may engage the software application on the client device 30 through the physical alert device 40. Therefore, in one embodiment the top wall 63 or either of the sidewalls 64 may contain one or more buttons 110. For example, shown is an impose button 114 and a delete button 112. A user will press the impose button 112 on coming across a navigational point of interest that has not been previously added by the user or received from the parent data store 10 to be displayed on the screen of the client device 30. The navigational point of interest added in this fashion may be deemed temporary or permanent on the software application and depending on user settings or application logic be shared with remote client devices 30b or uploaded back to the parent data source 10. Alternatively, the inputs may be classified by button clicks, such as a single click for a camera, two clicks for a temporary camera 3 clicks for permanent camera, four clicks for a speed trap dual press (112 and 114) for temporary speed sensor or double dual press for a permanent one, and a single right click of button 112 for delete, and so forth.

FIGS. 9B, 9C and 9D demonstrate another embodiment of the alert device 40. Shown in FIG. 9B is an embodiment of the physical alert device 40 having a button 112 along its top wall 62. A user may register a new temporary, semi-permanent or permanent navigational point of interest upon noticing such porting of interest while driving. The user need not take eyes off the road to depress the button 112. The button 112, may additionally function as the microphone to accept a user's verbal input containing navigational point of interest. A user's input is preferably acknowledged by a flashing of the display screen 47.

FIG. 9C shows the bottom section 140 of the display device 40 demonstrating the actuator 146, which completes a circuit along the circuit board 142, which causes user input to be recorded on the software application (60). The depression of the actuator 146 also causes one or a plurality of LEDs 144 to illuminate, acknowledging the entry to the user. Also shown is an input/output or charge port 148. The LEDs 144 may be configured to illuminate in a plurality of color combinations to acknowledge or confirm that an entry of a navigational point of interest has been recorded with the software application (60). In addition, a user may configure using the configuration menu of the software application (60) the desired flash interval or color scheme or combination that a user wishes to see as a confirmatory illumination and as an output alert. Additionally, each of the LEDs 144 may be operated individually and independently of other LEDs 144. Therefore, a user may configure a specific confirmatory flash or alerting flash to a particular navigational point of interest or alert. For example, a temporary vehicle-based speed sensor should be bulbs two and three, a general speed camera, bulbs one, two and five, a confirmatory entry for a red-light camera, bulbs one and five, with bulb one being green and bulb five being red. An infinite number of combinations may be supported by the flashing screen display 47. The circuit board 142 processes signals received from an electronic device (30) to generate alerts via a flashing screen display 47 or an audio message and initiates messages containing user input via the actuator 146 to the client device 30.

FIG. 9D is a diagram of the top section 122 of the alert device 40 showing a battery compartment 127 containing a battery 128. Rear snap rods 126 and front snap rods 129 hold the battery 128 removably in place. The actuator rod 124 is in contact with the actuator 146 at one end and the button 112 at its other end, or with the top wall 63 forming its top end. Depressing the button 112, or the entire top wall 63 causes the actuator rod 124 to depress the actuator 146, thus completing the circuit and recording user input.

FIG. 9E demonstrates another alternative embodiment of the physical alert device 40. The embodiment shown provides a key cluster 132. Each one of the keys in cluster 132 is in close proximity to the adjoining keys and is shaped differently than the adjoining keys of the cluster 132. The various shapes of the keys 132 are configured to induce tactile recognition of the key functions. A user is able to recognize what each key does without needing to take eyes off the road. While different key clusters 132 are possible, the cluster shown is configured to enter into the onboard storage of a client device (30) associated with this physical alert device the following navigational points of interest: the speed camara 133, traffic hazard 134, police sentinel 135 or police activity, accident key 137, and a hazard key 136. Additional or fewer keys may be possible, and a different configuration may also be possible. The speed camera sensor 133 is the most common navigational point of interest and is therefore centrally placed. Alternatively, the keys may be arranged in any configuration, shape or cluster. Any of the keys provided may also be utilized to adjust the intensity of the alert. For example, a user may hold down a speed camera sensor 133 for a period of time causing the alerting flash to be dimmer during an alerting action or lowering the degree of vibration or flashing of other equipment withing the vehicle 90 used for alerting.

Additionally, the key cluster 132 is integrated with a microphone to accept commands using voice activation, and a microphone to confirm a command or communicate a message (32) from another user. As shown in FIG. 9C, a depression of any of the keys preferably produced a confirmation flash from a different LED diode 144 or a combination of diodes/bulbs 144. For example, a speed camera key 133 would produce a confirmatory flash from two middle bulbs 144, or bulbs of red color, while a sentinel key 135 may produce a blue flash or a confirmation from diodes at the edges of the key cluster 132. The flashing of diodes is visible to a user through screen 138. Notably any other type of confirmatory flashes is possible. The difference between the assenting flashes on the physical alert device are preferred as a final check to the inputting user that the database was updated with the appropriate navigational point of interest.

FIG. 10B demonstrates an additional function of the physical alert device 40 or the software application (60) running on the client device 30, which connects to a vehicles entertainment system (57) and may direct alerts regarding navigation points of interests directly to the navigation screen 160 or to a holographic heads-up projection 150. The client device 30 communicates with the physical alert device 40 when the client device 30 is in radio wave range with the client device (30). When the client device (30) does not detect the physical alert device, the client device (30) may be configured to place the software application into a passive state to conserve battery with only a periodic probing to detect the physical alert device 40 is enabled, and once a physical alert device 40 is enabled, the software application 60 automatically connects to the detected physical alert device 40, with the software application 60 becoming active.

The client device (30) running the software application (60) would primarily be a mobile phone or a tablet computer. Alert published to the holographic heads-up projection display 150 may alternatively originate from the software application (60) and be transmitted by the client device (30) directly to the vehicle's internal infotainment or navigation systems. Some of the secondary receivers of the agitational alert messages from the software application 60 may be other interior features of the vehicle, such as seats, interior lighting and steering wheel, which may vibrate, flash or illuminate when an agitational alert is received from the software application 60.

FIG. 10 demonstrates another embodiment of the disclosed system. While a user may update the parent data storage or onboard database with additional navigational points of interest by using keys (110) on the physical alert device 40, additional input keys may be integrated into the vehicles circuitry, for example on the dashboard 210, thumb buttons 211 may be provided on a poke of a steering wheel 250. The software application (60) may be configured to connect to vehicle's API. A vehicle's infotainment system's output screen 232 may be further instrumented to contain the virtual or touch keys 234 that are configured to update the parent data storage or onboard database with additional navigational points of interest via input from a user. When instrumented into a vehicle's equipment, the keys may be interacted with the software application (60) running on vehicles native circuitry or may alternatively seek a proximally located client device 30 and become enabled on user preference or if the client device 30 is not available for such input, or if the client device 30 directs that the input be the keys located within vehicles equipment (210, 211 or 234). Also shown in FIG. 10B is a clip-on device 212. The clip-on device may be plugged into an input port of a vehicle or may function through short range radio signal to interact with the client device 30, or the software application (60) running by vehicle's electronics or on a client device 30. The software application 60 would be configured to accept input from an external device.

The software application (60) on the client device 30 that is proximate to the particular vehicle may be configured to utilize various vehicle interior equipment features (90) to generate the alert. For example, alerts may be generated by lighting the frame around the gadgets 230 around the instrument panel various buttons or infotainment screen equipment, The infotainment system may be configured to execute a copy of the software application (60) which would trigger the alert device 40 or the instrument panels 230 to display visual or audio alerts when detecting proximity to a navigational point of interest. It should be noted that alerts can be generated by utilizing any other equipment within a vehicle, such as vibration of the seats 240 or control stalks, such as the gear shift stalk 260. Additionally input keys may be located anywhere on the surface of the vehicle interior, or user input may be created through verbal commands.

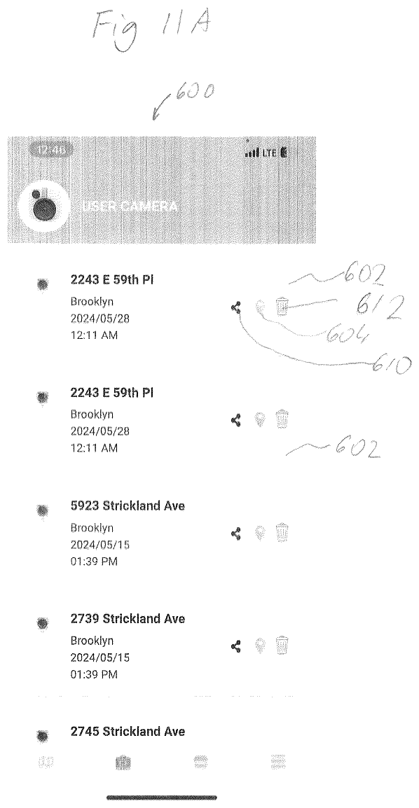

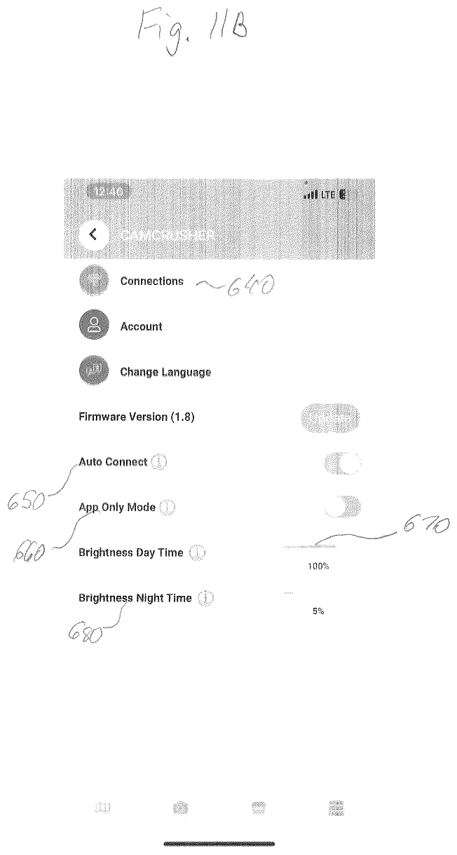

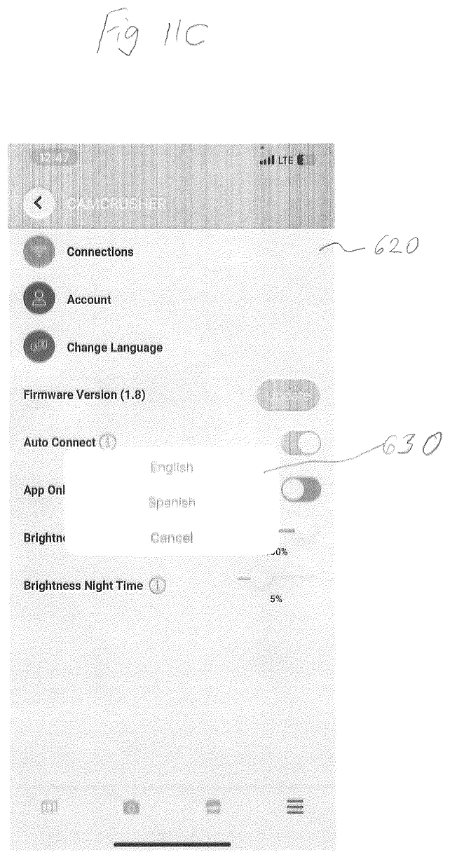

FIG. 11 demonstrates the various types of navigational points of interest 10a that may be stored on an onboard database of the software application (60) or as a record with the external data storage 10. The software application or the computer application (60) may monitor a plurality of navigational points of interest 10a, which may be standard road hazards, standard traffic enforcement activity, or any other object to be monitored. Included in this class of navigational points of interest 10a may be some type of shared alert 11a. A shared alert 11a is preferably an alert shared by another user of a software application 60 or shared by users of a common community or user group.

Other points of navigational points of interest 10a may include standard traffic enforcement devices, such as speed cameras 11b, traffic light cameras 11c, noise monitors, etc.

A shared alert 11a may also be customized based on priority or a special need of a common interest group or user that has created it. For example, if a group of common interest is a parcel delivery service, a shared alert may be a parcel pickup or delivery location. If a common interest group or user is a trucking company or operator, they may require customized points of interest 11d, which may be comprised of weight restrictions, weighing stations, inclement weather locations, or low overpasses, in addition to standard hazards 11a-11c. Other navigational points of interest 10a may be recognized by the software application itself 11e, when connecting to an external camera or built in camera of the client device (30). Using the camera, the software application may dynamically detect visible objects that may appear as hazards or points of enforcement

It is preferred that a user is able to distinguish between the various types of alerts 11a-11e through a difference in alerting signal on the physical alert device 40. For example, the shared alert 11a may activate bulbs one and five on the physical alert device 40, while the speed camera 11b will turn on the full screen 138 and stay lit until the detection zone of the speed camera has been passed. Ather alert features, such as custom points of interest 11d or software generated alerts 11e may illuminate using different colors or flashing sequences.

During operation the user may set stored attributes that further finetune the alerting experience. For example, a user may utilize the software application's 60 configuration menu 620 to set the minimum distance when an alert will be shown in attribute 12a. The minimum distance attribute 12a will be maintained irrespective of the hazard, but calibrating speed of travel to accurately meet the preset minimum distance attribute 12a. The configuration menu 620 provides an additional granularity where a user may adjust alerting based on desired distance or time prior to encountering a navigational point of interest, and where such setting can be specified for every speed or speed range. Thus, a user traveling 80 kph may wish to be alerted at least 30 meters or five seconds prior to encountering the navigational point of interest. On the other hand a user traveling 160 KPH may wish to be alerted at least one to three minutes or 300 meters before encountering a navigational point of interest. Additionally, an exit attribute 12b may be defined in the application based on the hazard or configured by a user on the software application's 60 configuration screen. In some cases, enforcement sensors include two way cameras, which are configured to capture approaching and departing vehicles, or vehicles moving in both directions of traffic. The minimum distance alerting attribute 12a, the exit alert attribute 12b and the alert issue attribute 12c are all calibrated to accommodate for the specialized nature of a two-way camera, just as one example of this coordinated and configurable alerting. The alerting attribute 12c takes into account attributes 12a and 12b, the application will still determine what type of alert to issue based on whether a user configured unique alerting signals/illumination based on whether the alert was from a shared hazard 13a or a custom alert 13c, and if no specific alerting sequence was defined, based on default alerting 13b.

FIGS. 11A-11C show elements of the configuration menu 620 of the user interface 600 of the software application 60. The configuration menu preferably comprises many screens and is preferably instrumented to configure at least one detection or alerting parameter. The detection or alerting parameter determines parameters of minimum or maximum distance when the software application will begin alerting prior to encountering a navigational point of interest. At least one detection or alerting parameter may also include connection configuration of the client device with another client device 30 or a group or community of client devices or subscription of participation with a group of common purpose.

FIG. 11A demonstrates the interface 600 showing the listing of navigational points of interest, or rather the location of each navigational point of interest. Each such navigational point of interest entry 602 may be configured for the type of alert it will be identified with on the client device 30 or the physical alert device 40 (e.g. one or multiple bulbs, flashing screen, list screen, flashing at a specific pattern, etc.). Configuration parameter 602 may also set whether this navigational point of interest is a permanent, semi-permanent or sharable, or whether it should be shared with a particular common interest group or community. The connection parameter 610 may set the connectivity to the physical alert device 40 the vehicle interior (90) or preference of connecting to specific client devices, communities or common purpose groups, groups that share routes or vehicle classes. Additional configuration parameters may include, but are not limited to preferred language menu 630 and connectivity connection 620.

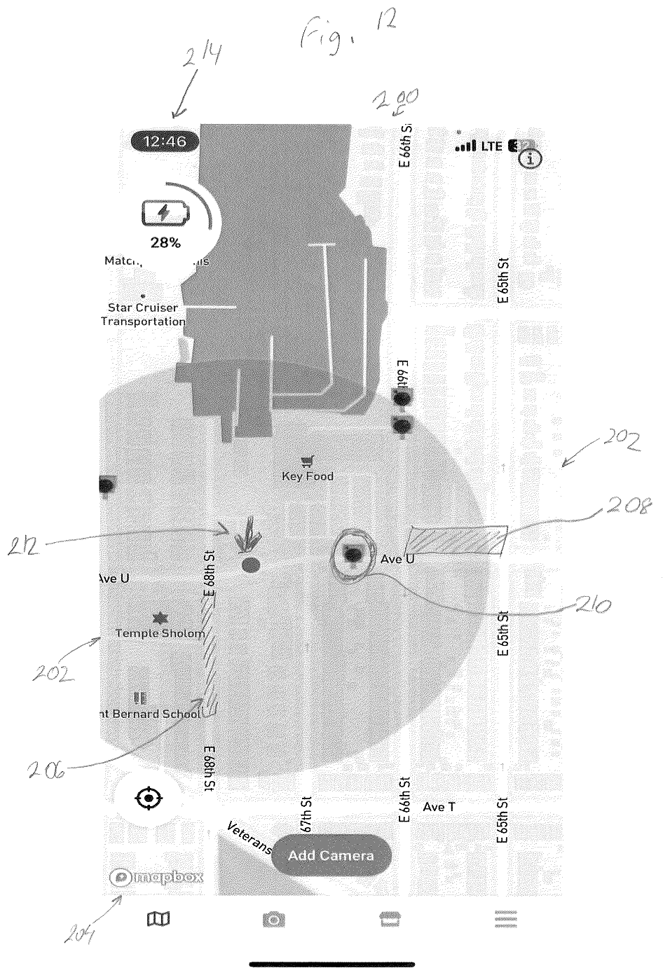

FIG. 12 illustrates alerting that does not reply on the physical alert device 40 but may utilize the screen of the client device 30. It is important to note that a screen presents many different ways by which an alert can be communicated. As one example, border 202 may flash a colored heavy boarder along with some audio sound or on its own. A section of a road being monitored may show as a flashing or solid color 206. A traffic camera sensor may begin alerting using a colored circle which may be additionally a flashing, or a floating arrow 212 may be displayed at particular navigational points of interest 10a, for example, custom navigational alerts (11d). Additionally, more native elements of the screen may be converted into alerting objects, such as the time symbol flashing different colors or featuring a flowing or circling border.

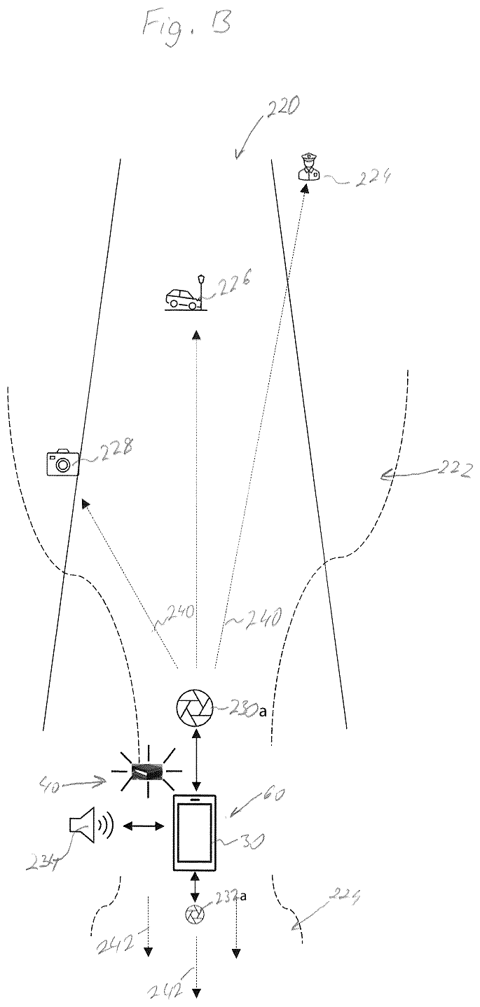

The software application 60 is able to learn of hazards dynamically using visual recognition and computer learning properties of the application 60, or by using radar detection mechanisms. Shown in FIG. 13 is a roadway 220. A client device 60 is traveling in the direction 222, which also represents the frontal field of detection. The software application may be coupled to a camera device 230a, which may detect surrounding features, such as a traffic enforcement 224, a roadside hazard 226 or a monitoring hazard 228. These hazards may be detected using environment recognition or hardware recognition from some distance and recognized based on features that software application 60 has determined from prior encounters to be indicative of certain types of hazards or enforcement devices. Such recognition and comparison to known hardware devices and known hazards may be done locally by the client device or at the parent database level (10). Either way the software application 60 would be configured to compare the detected hardware or environment to the images or features of hardware or environment already in the system and if the resemblance is confirmed, either the client device or the parent database may add the detected feature to the permanent or semi-permanent list of navigational points of interest. As a result, the software application 60 signals the physical alert device 40 to present an alert, which may identify this hazard as a computer-generated alert and as an alert configured through official records or through community contributions.

Alternatively, or in conjunction with visual recognition, the software may employ a radio wave detection device 234 to detect censor signals emitted by devices 228 or 224, or to identify obstacles such road accidents 226 or other hazards. The software application 60 may monitor the forward space 222 as well as the backward space 224 via a camera device 232a or radar detector trained at the backward space 224 to detect monitoring sensors trailing behind the vehicle carrying the device. Similarly, software application 60 may monitor the noise level or music volume emitted by the vehicle (91) housing the client application 30 and will issue an alert if the noise output is near or at legal limits of the geographic area where the client application 30 is located at that time.

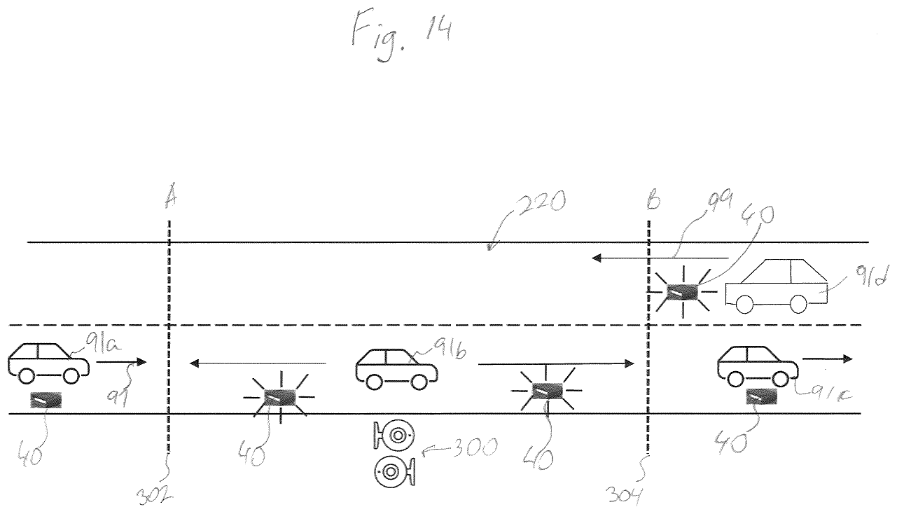

FIG. 14 demonstrates the automatic alert calibration of the software application 60 depending on the type of navigational point of interest 10a that is encountered. Shown in FIG. 14 is a two directional camera 300, which may also, or alternatively, serve as an average speed detection camera. A two directional camera monitors the speed of motorists moving in direction 97, toward point A 302 and in direction 99 toward point B 304. Stated in another way, a two directional camera 300 monitors all vehicular activity between points A 302 and point B 304. The vehicles may be moving toward or away from a two directional camera 300 in either direction along the section of the motorway 220. Similarly, a hazard 300 as an average speed camara would detect average speed of a moving vehicle between points A 302 and B 304 in one or both directions 97 or 99. The software application 90 is configured to detect the type of hazard encountered based on database information and trigger alerts at the physical alert device 40 or at the client device 30 to correspond to a) user desired or default distance between the client device 30 and navigational point of interest in question; and b) remain enabled throughout the monitored field (between points A and B) if dictated by the type hazard encountered.

In another embodiment a user may utilize the interface (600) of the client device 30 or the key cluster (132) to add point A 302 upon noticing a first camera of a zone being monitored by an average speed camera. The user can then select a point B 304 on noticing the second or exist camara of the zone being monitored by an average speed camera. The software application (60) running on the client device 30 will then utilize these entries to alert the user of the average speed camera zone between points A and B and furthermore, the software application (60) will be able to reverse the entry and exit cameras A and B when the client device is traveling through the same section, but in reverse direction.

In FIG. 14 the alert device 40 on the automobile 91b will continue alerting the entire distance between points A 302 and point B 304 since the hazard 300 is monitoring in both directions. If the hazard 300 is detected in only one direction, the software application 60 will signal the physical alert device 40 in the direction that is being monitored. For vehicle 91d moving in the direction 99 towards point B 304, the physical alert device 40 will begin alerting before point B 304 and then between points B 304 and point A 302, until vehicle 91d travels beyond point A 302. This covers the entire area covered by the navigational point of interest, which in this case is the hazard 300.

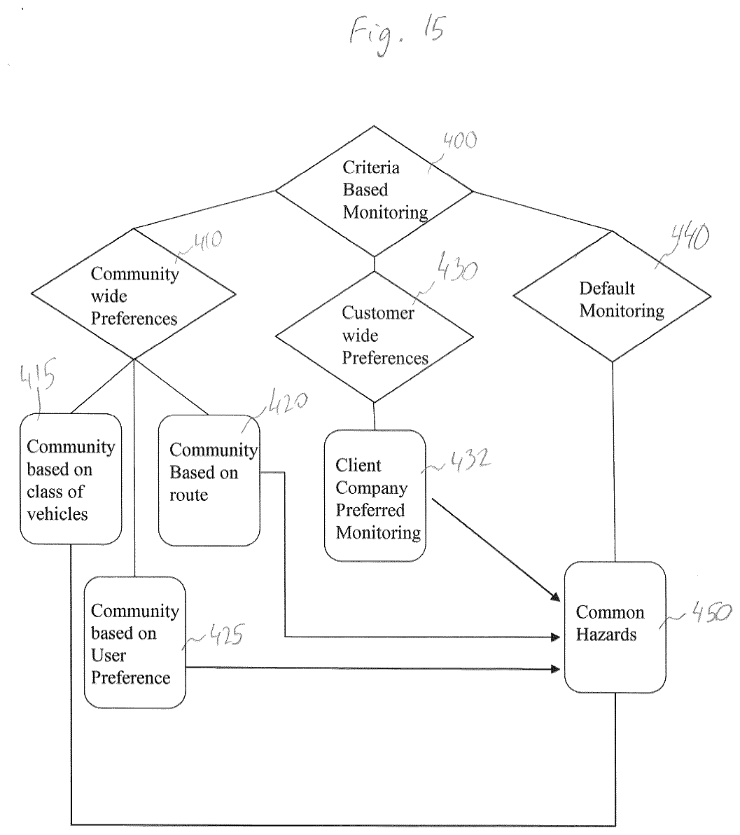

FIG. 15 demonstrates a community or tracking navigational points of interest (10a) based on groups of common interest 400. Shown in FIG. 15 are three general tracks of interest, although many more customizations of navigational points of interest are possible. The default monitoring 440 focuses on standard alerting for traffic enforcement spots, such as speed, or red-light cameras. Added to this are additional common hazards 450, such as road work, road closures, inclement weather, and traffic jams.

Some groups of common purpose include commercial outfits that may need the database of their client devices 30 to contain navigational points of interest that are important to the company 430. For example, pickup or drop off spots, delivery locations, for delivery companies. Weigh stations, and low overpasses for trucking companies. Or accident alerts and disabled vehicles for tow trucks. Some navigational points of interest can be populated by a central dispatcher for the commercial or professional outfit, which then loads such navigational points of interest to as many client devices as required and as many times as needed, even targeting specific client devices 30.

Other common purpose groups include community preferences 410, which consist of participating client devices 30 based on similar interests or preferences 425, based on alerting important to operators of specific types of vehicles 415 or users of a specific routes, for example a section of a highway between cities A and B.

The various alerting tracks such as community participation 410 or commercial and professional navigational points of interest 430 preferably monitor for standard points of interest, such as speed sensors, noise sensors and red-light cameras, as well as standard hazards 450, such as road work and crashes.

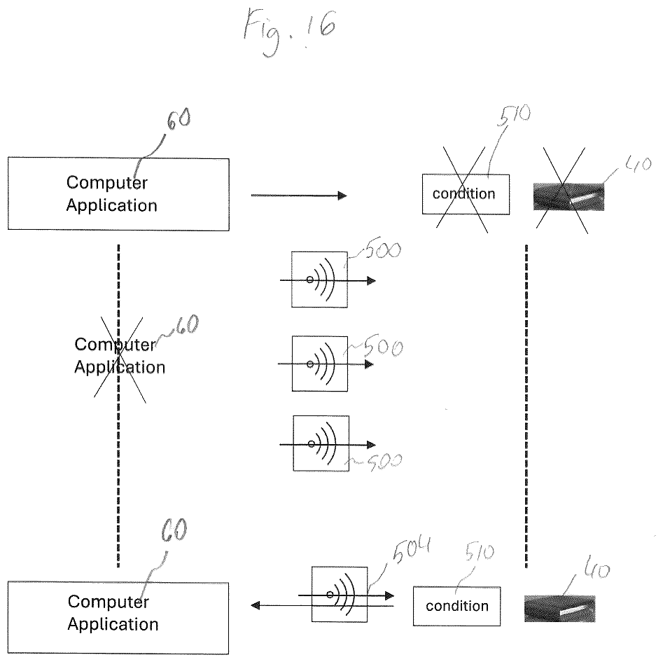

FIG. 16 is a demonstration of the sleep/wake states of the software application 60. The low intensity polling or pinging mechanism 500 may be configured to detect the presence of a condition 510, or the existence of the physical alert device 40 or a device similar to the physical alert device, such as instrumentation found inside a vehicle cockpit, and which can be utilized as physical alert devices by the software application 60. An example of condition 570 would be motion of the client device 30 that houses the software application 60. If the software application 60 is not in motion, the computer application 60 may be configured to shut down until motion begins again, which time the pinging mechanism 500 detects the presence of a condition 570, in this case motion, and starts the computer application 60. Alternatively, or in conjunction therewith, the software application 60 may be configured to connect to the physical alert device 40 or vehicle instrumentation as described in FIG. 10. If no such connection exists. The software application 60 may be stopped and then restarted in the event that the pinging or poling process 500 detects the presence of the physical alert device 40 or proximity to the vehicle or motion of such vehicle. It is preferred that the pinging process 500 would be executing independently from the software application 60, but tied to the extent that it is able to restart the software application 60 when the condition 510 becomes true of the physical control device 40 is within range and enabled. Additionally, the software application 60 may be actively stopped through an affirmative action by a user on said client device 30. However, as long as the pinging process 500 is still operating, the software application 60 will be automatically restarted by said client device 30 if the client device 60 comes into proximity with a physical alert device 60, vehicle interior 90, or if the condition being probed for by the pinging process 500 becomes true.

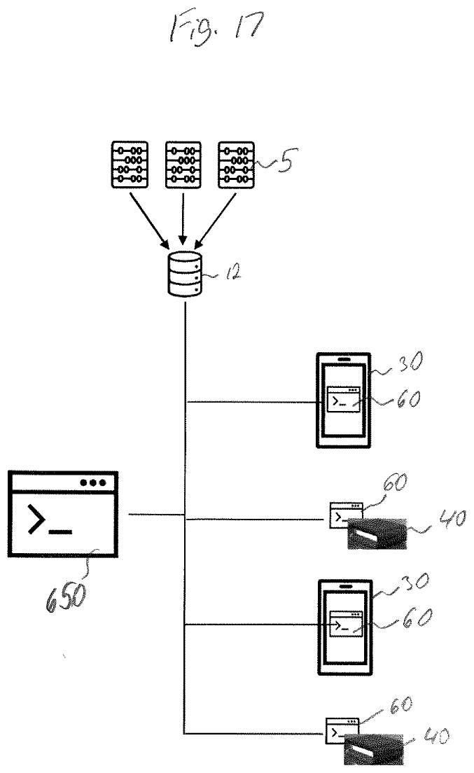

Shown in FIG. 17 an alternative embodiment of the alert system described in the instant application. The software application 60 is configured to run on either the client device 40 or the physical alert device 30. Each of said client device 30 or physical alert device 40 may function together if they are in proximity of short-wave radio with each other or independently. Either the client device 30 or the physical alert device 40 uses global positioning technology to identify whether it is moving in a particular direction, and whether the vector of this motion will intersect with a field being monitored by a navigational point of interest received from either or all of another one of client device 30 or another one of the physical alert device 40, from the parent database 10, or from a management console 650. It should be noted that both client device 30 and the physical alert device 40 are equipped with a geo-positioning chipset which is then utilized by the software application (60) executing on either the client device 30 or the physical alert device 40 to determine the location of the client device 30 or the physical alert device 40 on which it is running. Additionally, both the client device 30 and the physical alert device 40 may be equipped to store a local copy of the database comprised of navigational points of interest and their locations.

The management console 650 may be connected to a plurality of client devices 30 or a plurality of physical alert devices 40 and may communicate navigational point of interest to each individual client device 30 or physical alert device 40 or forward information received from one client device 30 or physical alert device 40 any number of the other client devices or physical alert devices. It should be noted that the management console 650 may create customized navigational points of interest, such as package drop off or pickup location for a parcel or package delivery service, or information regarding a heavily monitored sector. Each such custom navigational point of interest can be sent to the particular client device 30 or physical alert device 40 that needs such information.

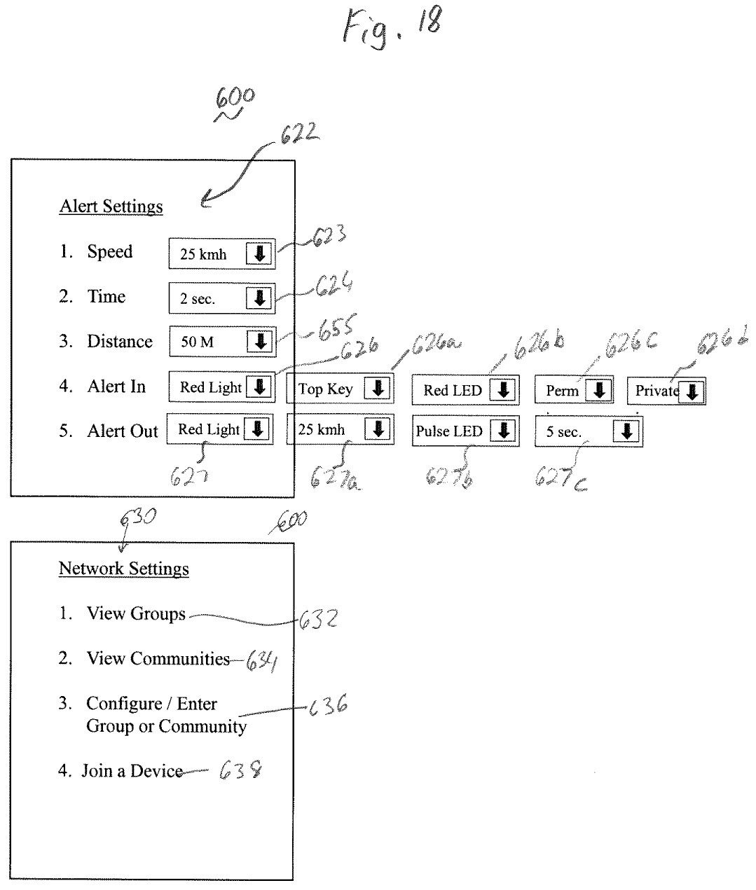

The software application 60 preferably allows a user to customize how navigational points of interest are detected, what types of interests should be detected, and once detected how or when an alert should be generated. Shown in FIG. 18 are two of the screen of the configuration menu (620) supported by the interface 600 of the software application (60). The alert settings menu 622 allows a user to configure alert settings for both user input and alert output, where the user input occurs when a user of a client device (30) or physical alert device (40), or vehicle cabin's instrumentation (90) wish to record a newly appearing law enforcement sensor, a roadway hazard or a customized point of interest. An alert output occurs when a physical alert device 40, the client device 30 or the vehicle cabin instrumentation (90) responds to an alert signal from the software application (60).

The speed setting 623 may be a virtual spin wheel or a drop-down box. On selecting a speed, for example 80 KM/h, the user can then select either the time 624 or the distance 625. Preferably, when either time 624 or distance 625 is selected, the software application (60) will consistently send alert signals in accordance with either the time to travel to the navigational point of interest that is being alerted to, or the distance that it will take to travel to said navigational point of interest, depending on which setting is enabled. A user would also be able to configure setting on recording a particular alert, by selecting the navigational point of interest 626 from a drop down, then selecting a key setting 626a to configuring which key, keys or voice command will create the entry within the national point of interest being entered on the software application 60. The user can then configure the confirmatory signal for user entry using the menu 626c and configure whether this should be a shared or public point of interest via the setting 626d. Similarly, the alert generated by the physical alert device 40, client device 30, or vehicle instrumentation (90), can be similarly configured using the navigational point of interest selection 627, whether to create a count down until the navigational point of interest via the selection 627a, what the alert output should be using selection 627b, and how long the alert signal should be maintained using the selection 627c. Notably, the alert settings 626 and 627 may accept custom navigational points of interest, or those populated by the parent database 5 or administrative screen 650. The user can then click on the save icon 628b to save the settings for the given speed 623 or cancel the setup using the icon 628a.

Similarly, the network configuration screen 630 allows a user to configure participation in a group of common purpose using the menu 632, or participation within a community via the selection 634. The group selection 632 and community selection 634 preferably permit a user to be removed or added to the particular group or community, what specific navigational points of interest should be exchanged within such group or community, and what kind of alerting should be used to distinguish a groupwide navigational point interest versus a standard or default navigational point of interest. Additional setting menus 636 and 638 will permit fine tuning of participation within a group or community or to join/remove cooperating client devices 30.

In another embodiment the software application (60) may receive or derive some of the navigational points of interest from available or perceived sources that may be charged with or are responsible for enforcing certain regulations. One example of such a source may be a governmental or private agency tasked with operating or regulating public transport, in particular, bussing. A municipal bussing authority may create a series of priority corridors, such as bus lanes 750, for its busses to ensure that members of the using public transportation have priority on the road when it comes to avoiding traffic. To ensure that a bus lane 750 remains open, a municipality may place stationery sensors and cameras as disclosed, or mobile sensors or cameras 752 on the buses themselves. The software application (60) preferably posses the means to alert a motorist against both stationary and mobile cameras 752 to prevent a motorist from unwittingly drifting into a restricted lane 750.

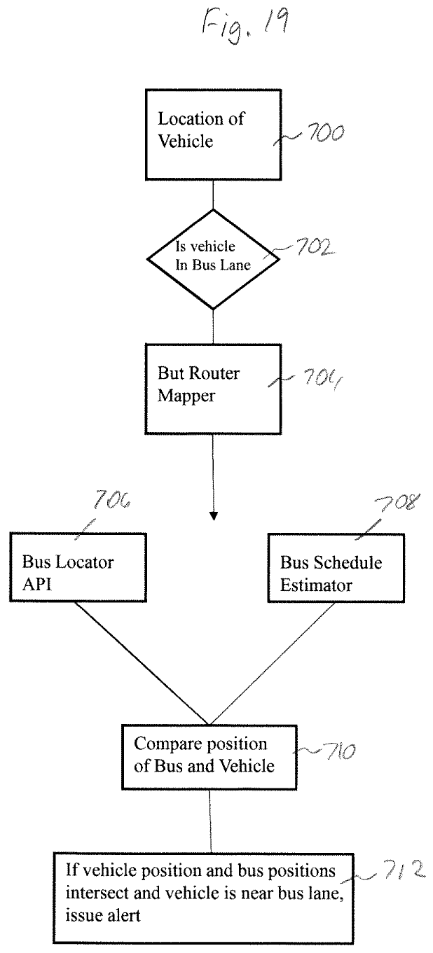

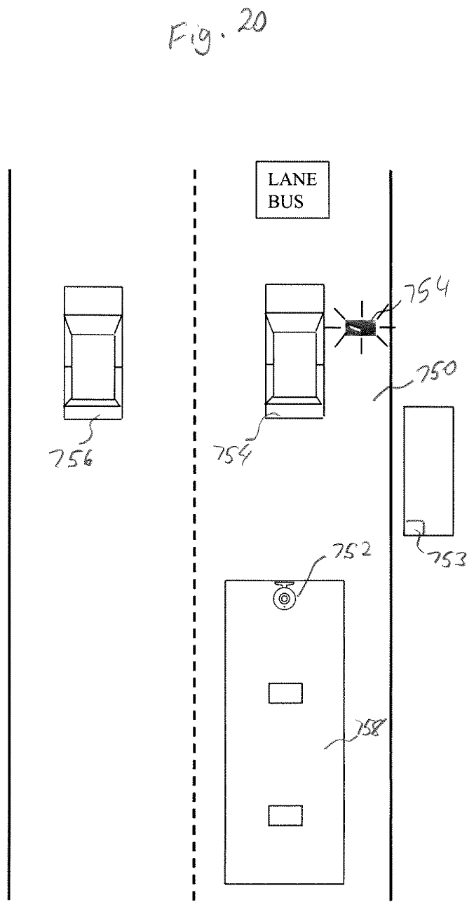

FIGS. 19 and 20 describe one methodology of identifying proximity to navigational points of interest that are mobile cameras 752. The calculation begins with global positioning 700 of a vehicle employing a client device (30). If a bus lane global positioning 700 determines that the vehicle 756 has indeed invaded a bus lane 754, for example to make a righthand turn, the software application (60) engages a bus router mapper process 704, which will attempt to identify the nearest stationary sensor 753 or a mobile camera 752. A mobile camera 752 would be mounted on a bus 758. Since each physical bus vehicle 758 is assigned to a particular schedule that day, the bus router mapper 704 will attempt to identify a location of a nearest bus that corresponds to the route that corresponds to the physical location 700 of the vehicle 754, using a publicly available application system interface 706 shared by the municipal bus company, which may otherwise be used to determine the approximate time of arrival of the next bus, or it may determine location of a bus by corresponding present bus location using the bus schedule estimator 704. Additionally, a presence of the bus 258 may be identified by the rear facing camera (232a FIG. 13), which the software application 60 would then interpret to contain the mobile camera 752, or if the mobile camera 752 is likewise detected by a camera device (232a FIG. 13) which is then compared to existing images known to software application (60), which then concludes whether the mobile camera 752 is a navigational point of interest for the vehicle 754. This is done by determining whether the vehicle location 700 intersects the bus location 710 if so, an alert is issued 712 to the physical alert device 40 on the vehicle 754.

Although this invention has been described with a certain degree of particularity, it is to be understood that the present disclosure has been made only by way of illustration and that numerous changes in the details of construction and arrangement of parts may be resorted to without departing from the spirit and the scope of the invention. While various inventive aspects, concepts and features of the inventions may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts, and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims, as currently written or as amended or added in the future. Descriptions of exemplary methods or processes are not limited to inclusion of all steps as being required in all cases, nor is the order that the steps are presented to be construed as required or necessary unless expressly so stated.

1. An alert system comprising; a software application, said software application configured to run on a client device; wherein said software application configured to detect a proximity of said client device to at least one navigational point of interest; wherein said software application configured to signal for an alert on detecting said proximity; wherein said at least one navigational point of interest may be provided to said client device from a public database, through input at said client device, through an input received from at least one other one of said client device, or through identification by said software application.

2. The alert system of claim 1, wherein said software application further comprising a configuration menu, wherein said configuration menu instrumented to configure at least one detection or alerting parameter, contact with at least one other of said client device, or participation with at least one other group of common interest; wherein said at least one detection or alerting parameter includes ability to define a specific alert time interval or distance corresponding to a specific speed level.

3. The alert system of claim 2, wherein said client device further comprises a screen displaying a user interface, wherein said screen configured to display an alert in response to said signal from said software application, wherein said alert comprises a flashing icon or flag identifying said navigational point of interest, a flashing border, a highlighted field on a map, a change in screen appearance, an audio signal or any combination thereof.

4. The alert system of claim 3, wherein said software application may utilize hardware of said client device to issue alerts is response to said alert signal, wherein said hardware includes an integrated flash or audio device or a screen output.

5. The alert system of claim 3, wherein said configuration menu is instrumented to permit configuration of said at least one navigational point of interest, of said signal, and of said alert in response to said signal.

6. The alert system of claim 5, wherein said at least one navigational point of interest is a speed sensor, a traffic camera, a volume sensor, a two way camera, an average speed sensor, an road closure, road work, an accident, a weather event, an custom entry by a user of said client device, an entry received from at least one other client device, an entry received from a group of common purpose, an entry received from a parent database, or any combination thereof.

7. The alert system of claim 6, wherein said client device may be configured to receive said at least one navigational point of interest from at least one other client device, from at least one community, or from at least one group of common purpose; and wherein said client device may be configured to send at least one navigational point of interest to at least one other client device, to at least one community, or to at least one group of common purpose.

8. The alert system of claim 7, wherein said client device is configured to send an alert signal to at least one physical alert device; wherein said at least one physical alert device is in proximity to said software application.

9. The alert system of claim 8, wherein said at least one navigational point of interest may be recorded to a local database on said client device by a user entry on said client device or a user entry on said physical alert device.

10. The alert system of claim 9, wherein user may utilize said client device or said physical alert device to define a zone being monitored by said navigational point of interest by identifying a point A and a point B; wherein said point A marks a start of an area being monitored by said navigational point of interest and wherein point B marks an end of said area being monitored by said navigational point of interest; and wherein said software application on said client device or said physical alert device is configured to maintain alerting of said zone; and wherein said software application is configured to identify said zone whether said client device or said physical alert device enters said zone from said point A or from said point B.

11. The alert system of claim 9, wherein said software application is associated with a pinging process; wherein said pinging process is configured to run in conjunction with said software application; and wherein said software application may be shut down through a configuration parameter or by a user on said client device; and wherein said software application is configured to be restarted automatically on said client device if said pinging process detects a condition or a proximity to said client device to said at least one physical alert device.

12. The alert system of claim 8, wherein said physical alert device further comprises a screen display, said screen display having a plurality of light sources; wherein said light sources may be configured to illuminate in a plurality of combinations of individual or groups of said plurality of light sources, or combination of colors of said plurality of said light sources, in confirmation of a user entry or on illumination in response to said alert signal.

13. The alert system of claim 9, wherein said physical alert device is instrumentation and hardware of a vehicle's interior; wherein said vehicle is in proximity to said software application.

14. The alert system of claim 13, wherein said instrumentation and hardware may be utilized by said software application to display said alert; wherein said alert may be displayed by a change on a screen or instrument panel of a vehicle's infotainment system or displayed by a visual, physical or audio signal emitted from said vehicle's instrumentation in response to said alert.

15. The alert system of claim 12, further comprising at least one camera, said at least one camera trained on approaching or departing environment; wherein said software application configured to detect at least one object within said approaching or said departing environment; wherein said at least one object resembling said at least one navigational point of interest.

16. The alert system of claim 15, wherein said software application configured to add said at least one object that has been detected to a local database as a navigational point of interest.

17. The alert system of claim 13, further comprising at least one camera, said at least one camera trained on approaching or departing environment; wherein said software application configured to detect at least one object within said approaching or said departing environment; wherein said at least one object resembling said at least one navigational point of interest; and wherein said software application configured to add said at least one object that has been detected to a local database.

18. The alert system of claim 15, wherein said client device further comprising a sound sensor, said sound sensor coupled with said software application; wherein said sound censor configured to identify a noise emitted in proximity to said client device; and wherein said software application configured to send said alert signal when traveling within proximity of said at least navigational point of interest that is a noise sensor if said noise is louder than minimum decibel level being detected by said at least one navigational point of interest.

19. The alert system of claim 18, wherein said at least one client device is integrated into an infotainment system of a vehicle.

20. The alert system of claim 11, wherein said at least one client device further comprising a supplemental connection function; and wherein said at least one client device is configured to communicate with a vehicle's entertainment system or a vehicles' navigation system using said supplemental connection function or a primary radio channel connection.

21. The alert system of claim 18, wherein said physical alert device is configured to be used to update said at least one navigational point of interest on said client device.

22. The alert system of claim 19, wherein said software application is configured to automatically share each update or each entry of said at least one navigational point of interest by a user with at least one other second alert receiver.

23. An alert system comprising; a software application, said software application configured to run on a client device; wherein said software application configured to detect a proximity of said client device to at least one navigational point of interest; wherein said software application configured to signal for an alert on detecting said proximity; wherein said at least one navigational point of interest may be provided to said client device from a public database, through input at said client device, through an input received from at least one other one of said client device, or through identification by said software application.

24. The alert system of claim 23, further comprising a parent database wherein said parent database configured to send said at least one navigational point of interest to at least one said client device; and wherein said parent database is configured to receive others of said at least one navigational point of interest from another of said at least one client device, or from a community or group; and wherein said parent database configured to forward to said client device to forward said other of said at least one navigational point of interest to said said client device.

25. The alert system of claim 24, wherein either said client device or said physical alert device each independently configured to operate a software application, receive said at least one navigational point of interest or said other of said one navigational point of interest and wherein said client application or said physical alert device each independently configured to emit an alert when said client device or said physical alert device travels into proximity with a geographical location of said navigational point of interest.

26. The alert system of claim 25, wherein said client device is configured to determine its location using global positioning; or wherein said physical alert device is configured to determine its location using global positioning.

27. The alert system of claim 26, further comprising a management console, said management console; wherein said management console configured to create at least one navigational point of interest to be sent to at least one of said client device or said physical alert device.

28. The alert system of claim 27, wherein said client device or said physical alert device each provides a user with ability to record another of said at least one navigational point of interest to be stored on a device wherein said another of said at least one navigational point of interest was recorded or to be forwarded to a parent database or to be forwarded to said management console.

29. The alert system of claim 28, wherein said configuration menu may be utilized to configure issuance of said alert in accordance to a distance of travel to or from said navigational point of interest or in accordance with time travelled toward or away from said navigational point of interest; or wherein said configuration menu may be utilized to configure issuance of said alert in accordance with speed of travel of said client device or in accordance to a distance of travel to or from said navigational point of interest or in accordance with time travelled toward or away from said navigational point of interest; and wherein said distance of travel or said time traveled may be configured for each individual at least one of said navigational point of interest.

30. The alert system of claim 29 wherein said software application is configured to detect a stationary or mobile navigational point of interest in proximity to said client device; and wherein said software application is configured to generate an alert signal if said client device intersects a point along a roadway lane being used by said client device, if said point is being monitored by said stationary or mobile navigational point of interest.
